(19) United States
(12) Patent Application Publication
(10) Pub. No.: US 2015/0181901 A1
(43) Pub. Date: Jul. 2, 2015

(54) Compositions and Methods for Tissue Storage

(71) Applicant: David SCHAPP, Irvine, CA (US)

(72) Inventor: David Scharp, Irvine, CA (US)

(21) Appl. No.: 14/390,563

(22) PCT Filed: Apr. 4, 2013
(86) PCT No.: PCT/US2013/035329

§ 371 Date: Oct. 3, 2014

Related U.S. Application Data
(60) Provisional application No. 61/620,689, filed on Apr. 5, 2012.

(51) Int. Cl. A23B 4/20; A23L 1/315; A23L 1/31

(52) U.S. Cl. CPC A23B 4/20; A23L 1/31; A23L 1/3155; A23V 2002/00

(57) ABSTRACT

The disclosure provides methods, and related compositions, for treating tissue with trehalose, where treatment reduces water loss during subsequent storage, for example, frozen storage.

### RELATED APPLICATIONS

This application claims the full Paris Convention benefit of, and priority to U.S. Provisional Application No. 61/620,689, filed Apr. 5, 2012, entitled “Novel Enhanced Compositions and Methods for Tissue Storage,” which is incorporated herein by this reference, as if fully set forth herein in its entirety.

### FIELD OF THE DISCLOSURE

The present disclosure relates to methods, and related compositions, for preparing tissues for storage, including but not limited to numerous applications further comprising for eventual use as a food source or for medical transplantation, tissue remediation and other purposes.

### BACKGROUND OF THE DISCLOSURE

Meat processing can involve storage in the cold, sometimes including freezing and thawing, where adverse effects occurring during storage include water losses, for example, in the form of drip loss. Studies on maintaining water-holding capacity, or reducing drip loss, have addressed a number of variables that influence water loss. These variables include rates of freezing and thawing (Eastridge and Bowker (2011) J. Food Sci. 76:S156-S162; Lagerstedt et al (2008) Meat Sci. 80:457-461; Rosenvold et al (2010) J. Anim. Sci. 88:1830-1841); pre-slaughter stress (Young et al (2009) Meat Sci. 83:634-641); and genetics and breed (Brunner et al (2012) Mol. Biol. Rep. 39:97-107; An et al (2010) Poultry Sci. 89:1750-1754).

Freezing can preserve tissues intended for food, but freezing can result in water loss from the tissues. Regarding frozen muscle, subsequent thawing results in contraction, where the contraction provokes release of water. Restricting the shortening, that is, restricting contraction, during thawing prevents water release. This indicates that the contraction expels the water, either from in between contractile fibers or from interstitial spaces (Kaminer (1962) J. Gen. Physiol. 46:131-142). Mazur (1984) Am. J. Physiol. 247:C125-C142, discloses a few features that may occur with cooling of cells. If cooling is relatively slow, the cell loses water, and is able to lose water rapidly enough to concentrate intracellular solutes. The result of the concentrated intracellular solutes is that the cells do not freeze intracellularly. However, if the cell is cooled relatively quickly, the cell is not able to lose water fast enough to create increased intracellular solutes concentration, and intracellular freezing occurs. The high concentrations of intracellular solutes, as might be achieved during freezing, can be toxic to cells (see, e.g., US 2010/0151437 of Taylor et al, which is hereby incorporated by reference in its entirety). Koopmans et al (US 20020102239), which is incorporated by reference, also discloses water loss during the freezing of cells, and notes deleterious effects of cooling rates that are too fast or slow. Attempts to reduce water loss during freezing include, for example, altering the rate of cooling (Kardak et al (2007) J. Biomech. Eng. 129:688-694).

Tissues destined for medical uses need to be stored during transport or shipping. These tissues include organs, biopsies, and populations of individual cells. The human pancreas, for example, can be acquired from human donors, and then used for medical purposes, such as for the isolation and culture of the Islets of Langerhans (see, e.g., Kühtreiber et al (2010) Transplantation Proc. 42:2027-2031). When a subject donates a tissue, tissue or organs to be donated may be cooled by cold perfusion and surface cooling, followed by storage at 4 degrees C. (Hernandez-Alejandro et al (2010) Can. J. Surg. 53:93-102). The conditions during cold ischemia during shipping or storage are one of the main factors to influence success of the transplant (Takemoto et al (2000) New Engl. J. Med. 343:1078-1084).

Present disclosure provides methods and reagents comprising trehalose, for treating tissues that are destined for food use or medical use.

### SUMMARY OF THE DISCLOSURE

In embodiments, the present disclosure provides methods, and related compositions, for treating tissue with trehalose, where treatment reduces water loss during subsequent storage, for example, frozen storage.

The present disclosure provides a method for processing a first composition that comprises muscle fibers, the method comprising: Step a. Contacting a solution of a first concentration of trehalose (Solution A) to a first composition that comprises muscle fibers; Step b. Incubating the first composition that comprises muscle fibers, for a pre-determined time, at a first temperature that is above freezing, in the presence of the Solution A; and Step c. Reducing or eliminating the presence of the Solution A; wherein the concentration of trehalose in the Solution A is capable of reducing weight loss of the first composition and is also capable of reducing water loss from the first composition, as determinable by subjecting to at least three cycles of freezing and thawing, as compared to a second control composition that comprises muscle fibers that was not incubated in the presence of trehalose, where the second control composition is subjected to the at least three cycles of freezing and thawing.

Also provided is the above method, wherein the first composition is meat for human consumption. Moreover, what is provided is the above method that does not comprise freezing. Also provides is the above method that further comprises freezing following Step c. What is further provided is above method, wherein the reducing or eliminating of the Solution A comprises draining or blotting. What is also encompassed is above method, wherein the pre-determined time is at least 12 hours and the first temperature is 2-10 degrees C. Also provided is above method, wherein the first composition that comprises muscle fibers does not comprise an organ or gland. Further provided is above method, wherein the first composition that comprises muscle fibers comprises meat that is one or more of beef, pork, poultry, fish, or shellfish. Also embraced is above method, wherein the first concentration of trehalose is at least 5% trehalose. Moreover, what is also contemplated is above method, wherein the first concentration of trehalose is at least 10% trehalose.

Further provided is above method, wherein the Solution A contains at least 5% trehalose, wherein three freeze-thaw cycles results in a fluid loss of N mL (N is a number) from a second composition (comparator composition) that is not treated with trehalose prior to freeze-thawing, and wherein three freeze-thaw cycles results in a fluid loss of under 80% of N mL from the first composition, wherein the first composition is treated with at least 5% trehalose prior to freeze-thawing. In embodiments, what is provided is above method, wherein the Solution A contains at least 5% trehalose, wherein three freeze-thaw cycles results in a fluid loss of N mL (N is a number) from a second composition (comparator composition) that is not treated with trehalose prior to freeze-thawing, and wherein three freeze-thaw cycles results in a fluid loss of under 70% of N mL from the first composition, wherein the first composition is treated with at least 5% trehalose prior to freeze-thawing. Moreover, what is provided is above method, wherein the Solution A is at least 5% trehalose, wherein three freeze-thaw cycles results in a fluid loss of N mL (N is a number) from a second composition (comparator composition) that is not treated with trehalose prior to freeze-thawing, and wherein three freeze-thaw cycles results in a fluid loss of under 60% of N mL from the first composition, wherein the first composition is treated with at least 5% trehalose prior to freeze-thawing.

In another aspect, what is provided is above method, wherein the contacting and incubating comprises one or more of soaking, dipping, or spraying.

In yet another aspect, what is provided is above method, wherein the first concentration of trehalose is at least 5% trehalose, and: (i) wherein the first and second compositions comprise poultry meat, wherein three freeze-thaw cycles results in a weight loss of at least 15% of a second composition (comparator composition) that is not treated with trehalose prior to freeze-thawing, and wherein three freeze-thaw cycles results in a weight loss of under 13% of the first composition, wherein the first composition is treated with at least 5% trehalose in Step b; (ii) wherein the first and second compositions comprise pork, wherein three freeze-thaw cycles results in a weight loss of at least 8% of a second composition (comparator composition) that is not treated with trehalose prior to freeze-thawing, and wherein three freeze-thaw cycles results in a weight loss of under 7% of the first composition, wherein the first composition is treated with at least 5% trehalose in Step b; or (iii) wherein the first and second compositions comprise beef, wherein three freeze-thaw cycles results in a weight loss of at least 15% of a second composition (comparator composition) that is not treated with trehalose prior to freeze-thawing, and wherein three freeze-thaw cycles results in a weight loss of under 13% of the first composition, wherein the first composition is treated with at least 5% trehalose in Step b.

In yet another aspect, what is provided is above method, wherein the first concentration of trehalose is at least 5% trehalose, wherein three freeze-thaw cycles results in a fluid loss of at least Y mL/10 grams of a second composition of comparator composition that is not treated with trehalose prior to freeze-thawing, and (i) wherein three freeze-thaw cycles results in a fluid loss of under 0.5 Y mL/10 grams of a first composition, wherein the first composition and second composition comprise poultry meat; (ii) wherein three freeze-thaw cycles results in a fluid loss of under 0.7 Y mL/10 grams of a first composition, wherein the first composition and second composition comprise pork; or (iii) wherein three freeze-thaw cycles results in a fluid loss of under 0.7 Y mL/10 grams of a first composition, wherein the first composition and second composition comprise beef.

What is further contemplated, is above method for processing a first composition that comprises muscle fibers, the method comprising: (i) contacting a solution of a first concentration of trehalose (Solution A), that is at least 5% trehalose, to a first composition that comprises muscle fibers; (ii) incubating the first composition that comprises muscle fibers, for a pre-determined time, at a first temperature that is above freezing, in the presence of the Solution A; and (iii) reducing or eliminating the presence of the solution of the first concentration of trehalose; wherein the first composition that comprises muscle fibers comprises increased number of horizontal fractures and increased number of moved around fragments, as determined by the steps of: (I) the first composition that comprises muscle fibers is incubated in the Solution A that is at least 5% trehalose for 12 hours at 4 degrees C., and the second composition (comparator composition) is incubated a control solution that does not contain trehalose for 12 hours at 4 degrees C.; (II) the Solution A is removed by draining and the control solution is removed by draining; (III) the first composition that comprises muscle fibers and the second composition that comprises muscle fibers are each subjected to two weeks of freeze-thaw cycling (freeze 24 h/thaw 24 h); and (IV) the first composition that comprises muscle fibers and the second composition that comprises muscle fibers are each fixed with formalin, stained with hematoxylin and eosin, and examined with a microscope.

In another aspect, what is provided is above method, wherein the increased number of horizontal fractures is at least 2-fold increased, and increased number of moved around fragments is at least 2-fold increased.

In composition embodiments, what is provided is a composition that comprises trehalose-treated muscle fibers, prepared by a method comprising: (a) contacting a solution of a first concentration of trehalose (Solution A) to a first composition that comprises muscle fibers; (b) incubating the first composition that comprises muscle fibers, for a pre-determined time, at a first temperature that is above freezing, in the presence of the solution of the first concentration of at least 5% trehalose; and (c) reducing or eliminating the presence of the Solution A; wherein the concentration of trehalose in the Solution A is capable of reducing weight loss of the first composition and is also capable of reducing water loss from the first composition, when subjected to at least three cycles of freezing and thawing, as compared to a second control composition that comprises muscle fibers, wherein the second control composition is not incubated in the presence of trehalose.

In another composition embodiment, what is provided is a composition that comprises a trehalose-treated composition that comprises muscle fibers, wherein the composition is prepared by a method comprising: (a) contacting a solution of a first concentration of trehalose (Solution A), that is at least 5% trehalose, to a first composition that comprises muscle fibers; (b) incubating the first composition that comprises muscle fibers, for a pre-determined time, at a first temperature that is above freezing, in the presence of the Solution A; and (c) reducing or eliminating the presence of the Solution A; wherein the first composition that comprises muscle fibers comprises increased number of horizontal fractures and increased number of moved around fragments, as determined by the steps of: (i) the first composition that comprises muscle fibers is incubated in a Solution A that is at least 5% trehalose for 12 hours at 4 degrees C., and the second composition (comparator composition) is incubated a control solution that does not contain trehalose for 12 hours at 4 degrees C.; (ii) the Solution A is removed by draining and the control solution is removed by draining; (iii) the first composition that comprises muscle fibers and the second composition that comprises muscle fibers are each subjected to two weeks of freeze-thaw cycling (freeze 24 h/thaw 24 h); and (iv) the first composition that comprises muscle fibers and the second composition that comprises muscle fibers are each fixed with formalin, stained with hematoxylin and eosin, and examined with a microscope.

The disclosure provides method for processing a composition that comprises a protein-containing matrix, the method comprising: contacting a solution of a first concentration of trehalose to a first composition comprising a protein-containing matrix, and incubating for a predetermined period of time at a first temperature that is above freezing, and storing the first composition for a pre-determined period of storage time at a second temperature; wherein the concentration of trehalose in the solution is capable of modulating the water content of the first composition during the pre-determined period of storage. Also provided is the above method, wherein the modulating is increasing, maintaining, or mitigation of losses of water or fluid. In another aspect, what is encompassed is the above method, wherein the first composition is a tissue. What is also embraced is the above method, wherein the first composition comprises a biological cell.

In another aspect, what is disclosed is the above method, wherein the second temperature is above the freezing point, or is at the triple point, of the solution of a first concentration of trehalose. Furthermore, what is provided is the above method, wherein the second temperature is below freezing. Moreover, what is embraced is the above method, further comprising: the step of removing the solution of the first concentration of trehalose, wherein the removing is conducted after the step of incubating in the first concentration of trehalose for a predetermined period of time at a temperature above freezing, wherein the step of removing is before the step of storing the first composition for the pre-determined period of time at the second temperature, and wherein the step of removing results in the removal of essentially all of the solution that is external to the composition. In yet another aspect, what is provided is the above method, wherein the first composition comprises a tissue, and wherein the tissue comprises at least one interstitial space, or at least one cytosolic compartment, or both, and wherein the contacting and incubation results in an increase in trehalose concentration in the at least one interstitial space, or the at least one cytosolic compartment, or in both.

Moreover, what is contemplated is the above method, further comprising a comparing step, wherein the comparing step comprises: contacting a solution of a second concentration of trehalose to a second composition comprising a protein-containing matrix, wherein the second concentration is a comparator concentration of trehalose for comparing with the first concentration of trehalose, incubating the second composition and second concentration of trehalose for the same predetermined period of time and same temperature at above freezing, as with the first concentration of trehalose, and storing the second composition for the pre-determined period of storage time at the second temperature.

Also, what is encompassed is the above method, wherein the first concentration of trehalose is 15% trehalose, and the second (comparator) concentration of trehalose is less than one percent (1%) trehalose. In yet another embodiment, what is provided is the above method, wherein the first composition comprises an outside surface, and wherein removing the solution of a first concentration of trehalose results in the first composition having a dry outside surface.

Moreover, what is also embraced, is the above method, wherein the first composition comprises a population of free cells, wherein the population of free cells comprises one or more of red blood cells, platelets, white blood cells, or cells prepared by in vitro cell culture, and wherein the contacting is to all of the cells in the population of free cells. In another aspect, what is provided is the above method, further comprises removing the solution and wherein removing the solution of a first concentration of trehalose, resulting in a preparation of packed cells.

Also disclosed, is the above method, wherein the first composition comprises meat. In yet another embodiment, what is disclosed is the above method, wherein the first composition comprises a tissue, wherein the tissue comprises meat, and wherein the meat comprises poultry, pork, beef, fish, or shellfish.

Moreover, a further disclosure encompasses the above method, wherein the protein-comprising matrix is for transplantation in a mammalian subject. An additional disclosure provides the above method, wherein the contacting comprises soaking or dipping. In yet another aspect, what is additionally embraced is the above method, wherein the contacting does not comprise soaking or dipping. Also, what is disclosed is the above method, wherein the contacting comprises perfusion via a blood vessel or via at least one injection. Embraced, as well, is the above method, wherein the contacting does not comprise perfusion. What is encompassed is the above method wherein the first composition comprises a tissue, and wherein the tissue comprises an organ, gland, or population of free cells.

In yet another aspect, what is contemplated is the above method, wherein the first composition comprises a tissue, wherein the tissue comprises an organ, and wherein the organ comprises heart, lung, liver, or pancreas. In composition embodiments, what is disclosed is a composition prepared by any one of the above methods, or by any combinations of the above methods.

Additionally, what is encompassed is the above composition, that comprises at least two complete horizontal fractures, in a field of about 100 square micrometers (or about 25, 50, 200, 400, 800, 1000, 2000, 4000, 8000, 10000, 20000, square micrometers, and the like), with a slice thickness of about 1 micrometer (or about 0.5, 2.0, 4.0, 6.0, 8.0, 10, 15, 20, 40, 80, 100, 200, 400, micrometers).

The disclosure provides a method for tenderizing meat, comprising processing a composition that comprises meat, the method comprising: contacting a solution of a first concentration of trehalose to a first composition that comprises meat and incubating for a predetermined period of time at a first temperature that is above freezing, and storing the first composition comprising meat for a pre-determined period of storage time at a second temperature; wherein the concentration of trehalose in the solution is capable of importing the water content of the first composition during the pre-determined period of storage. Also embraced is one or more of the above methods, and related compositions, further including the step of cooking, baking, frying, or heating, e.g., heating to an interior meat temperature of about 40 degrees C., 45, 50, 55, 60, 65, 70, 75, 80, 85, 90, 95, or about 100 degrees C., and the like.

In embodiments, disclosure includes a composition prepared by one of the above methods, as well as the above composition, that comprises at least two complete horizontal fractures, in a field of about 100 square micrometers, with a slice thickness of about 1 micrometer. Also encompassed, is above composition, that comprises an increase in nucleic acid in an amount that stains with hematoxylin and that has an absorbance of at least 0.01, as determined by a photography under high power with a light microscope, with a slice thickness of about 1 micrometer. In addition, what is encompassed is above composition, that comprises at least two complete horizontal fractures, in a field of about 100 square micrometers, with a slice thickness of about 1 micrometer, and that further comprises an increase in nucleic acid in an amount that stains with hematoxylin and that has an absorbance of at least 0.01. In another aspect, what is encompassed is above composition that comprises a composition that comprises a protein-containing matrix, the protein-comprising matrix comprising: a. Muscle that comprises a plurality of muscle fibrils and a plurality of muscle fibril bundles; b. Trehalose at a level of at least 0.01 mg/kg of the muscle; c. Muscle fibril fragments, wherein the muscle comprises said muscle fiber fragments; and d. Hematoxylin-staining material located in between muscle fibrils, in between the muscle fibril bundles, or both in between the muscle fibrils and in between the muscle fibril bundles.

The present disclosure encompasses any combination of each independent Claim with one, two, three, four, or all of the depending Claims. For example, where independent Claim 1 has three dependent Claims (Claim 2, Claim 3, and Claim 4), the present disclosure encompasses the combination of Claim 1+Claim 2; the combination of Claim 1+Claim 3, the combination of Claim 1+Claim 4, the combination of Claims 1, 2, and 3; the combination of Claims 1, 2, and 4; the combination of Claims 1, 2, and 4; the combination of Claims 1, 3, and 4; and the combination of Claims 1, 2, 3, and 4.

Embodiments encompass those with an absorbance (due to hematoxylin staining) of at least 0.05, 0.01, 0.015, 0.02, 0.04, 0.06, 0.08, 0.10, 0.15, 0.20, and the like. Also, embodiments encompass those with trehalose level of at least, 0.001 mg/kg of muscle, 0.005, 0.010, 0.02, 0.05, 0.10, 0.20, 0.50, 1.0 mg/kg of muscle, and the like.

### BRIEF DESCRIPTIONS OF THE FIGURES

FIG. 1. First freeze/thaw cycle. Volume of fluid lost during three freeze/thaw cycles.

FIG. 2. First freeze/thaw cycle. Percent change in weight, comparing start weight and post-soak weight.

FIG. 3. First freeze/thaw cycle. Percent of fluid loss, where loss with 0% trehalose is set at 100% fluid loss.

FIG. 4. First freeze/thaw cycle. Percent of weight loss of meat samples, comparing post-soak weight to post 3-freeze/thaw cycles.

FIG. 5. First freeze/thaw cycle. Volume of fluid (mL), per 10 grams of meat sample, lost with trehalose treatment.

FIG. 6. Second freeze/thaw cycle. Volume fluid lost.

FIG. 7. Second freeze/thaw cycle. Percent of fluid lost, where fluid loss with 0% trehalose is set at 100%.

FIG. 8. Second freeze/thaw cycle. Percent of weight lost.

FIG. 9. Second freeze/thaw cycle. Volume of fluid loss per 10 grams meat.

FIG. 10. Cumulative results for 1^{st} and 2^{nd} freeze/thaw cycles. Total volume fluid loss.

FIG. 11. Cumulative results for 1^{st} and 2^{nd} freeze/thaw cycles. Total percent fluid loss.

FIG. 12. Cumulative results for 1^{st} and 2^{nd} freeze/thaw cycles. Total percent weight loss.

FIG. 13. Cumulative results for 1^{st} and 2^{nd} freeze/thaw cycles. Total volume fluid loss per 10 grams meat.

FIG. 14. Cumulative results, 1^{st} freeze/thaw cycle, and 2^{nd} freeze/thaw cycle. Volume loss (Chicken).

FIG. 15. Cumulative results, 1^{st} freeze/thaw cycle, and 2^{nd} freeze/thaw cycle. Volume loss (Pork).

FIG. 16. Cumulative results, 1^{st} freeze/thaw cycle, and 2^{nd} freeze/thaw cycle. Volume loss (Beef).

FIG. 17. Cumulative results, 1^{st} freeze/thaw cycle, and 2^{nd} freeze/thaw cycle. Weight loss (Chicken).

FIG. 18. Cumulative results, 1^{st} freeze/thaw cycle, and 2^{nd} freeze/thaw cycle. Weight loss (Pork).

FIG. 19. Cumulative results, 1^{st} freeze/thaw cycle, and 2^{nd} freeze/thaw cycle. Weight loss (Beef).

FIG. 20. Chicken sample under moderate power, 0% trehalose.

FIG. 21. Chicken sample under moderate power, 15% trehalose.

FIG. 22. Chicken sample under high power, 0% trehalose.

FIG. 23. Chicken sample under high power, 15% trehalose.

FIG. 24. Chicken sample under high power, 15% trehalose.

FIG. 25. Pork sample under moderate power, 0% trehalose.

FIG. 26. Pork sample under moderate power, 15% trehalose.

FIG. 27. Pork sample under high power, 0% trehalose.

FIG. 28. Pork sample under high power, 15% trehalose.

FIG. 29. Beef sample under moderate power, 0% trehalose.

FIG. 30. Beef sample under moderate power, 15% trehalose.

FIG. 31. Beef sample under high power, 0% trehalose.

FIG. 32. Beef sample under high power, 15% trehalose.

### DEFINITIONS

“Administration” as it applies to a human, mammal, mammalian subject, animal, veterinary subject, placebo subject, research subject, experimental subject, cell, tissue, organ, or biological fluid, refers without limitation to contact of an exogenous ligand, reagent, placebo, small molecule, pharmaceutical agent, therapeutic agent, diagnostic agent, or composition to the subject, cell, tissue, organ, or biological fluid, and the like. “Administration” can refer, e.g., to therapeutic, pharmacokinetic, diagnostic, research, placebo, and experimental methods. Treatment of a cell encompasses contact of a reagent to the cell, as well as contact of a reagent to a fluid, where the fluid is in contact with the cell. “Administration” also encompasses in vitro and ex vivo treatments, e.g., of a cell, by a reagent, diagnostic, binding composition, or by another cell.

“Effective amount” encompasses, without limitation, an amount that can ameliorate, reverse, mitigate, prevent, or diagnose a symptom or sign of a medical condition or disorder. Unless dictated otherwise, explicitly or by context, an “effective amount” is not limited to a minimal amount sufficient to ameliorate a condition. “Therapeutically effective amount” is defined as an amount of a reagent or pharmaceutical composition that is sufficient to show a patient benefit, i.e., to cause a decrease, prevention, or amelioration of the symptoms of the condition being treated. When the agent or pharmaceutical composition comprises a diagnostic agent, a “diagnostically effective amount” is defined as an amount that is sufficient to produce a signal, image, or other diagnostic parameter. Effective amounts of the pharmaceutical formulation will vary according to factors such as the degree of susceptibility of the individual, the age, gender, and weight of the individual, and idiosyncratic responses of the individual. See, e.g., U.S. Pat. No. 5,888,530 issued to Netti, et al, which is incorporated herein by reference.

An “extracellular fluid” can encompass, e.g., serum, plasma, blood, interstitial fluid, cerebrospinal fluid, secretions, milk, chyme, lymph, bile, sweat, and urine. An “extracellular fluid” can comprise a fluid-like colloid or a fluid-like suspension, e.g., whole blood, non-coagulated plasma, or plasma with an effective anti-coagulant. Disclosure also provides methods for introducing trehalose into extracellular or interacellular: gels, colloids, coagulated suspensions, and the like.

A composition that is “labeled” is detectable, by spectroscopic, photochemical, biochemical, immunochemical, isotopic, or chemical methods. For example, labels include radioactive isotopes of phosphorous, iodine, sulfur, carbon, stable isotopes, epitope tags, fluorescent dyes, electron-dense reagents, substrates, or enzymes, e.g., as used in enzyme-linked immunoassays, or fluorettes (see, e.g., Rozinov and Nolan (1998) Chem. Biol. 5:713-728). Radioactive trehalose is available, for example, for use as a [¹⁴C]labeled or [³H]labeled tracer (see, e.g., Pan et al (1996) Glycobiology 6:453-461; Horlacher et al (1996) Appl. Environ. Microbiol. 62:3861-3863). Trehalose can be detected and quantified by, e.g., enzymatic assays, thin layer chromatography, or high pressure liquid chromatography (HPLC) (see, e.g., Managbanag et al (2002) Mycologia. 94:384-391; Kienle et al (1993) Yeast. 9:607-611; Mau et al (1997) J. Agric. Food Chem. 45:4726-4729).

The following provides guidance on the meaning of “reducing” or eliminating the presence of the solution of trehalose. To provide a non-limiting example, where a 100 gram sample of meat is soaked in 500 mL of trehalose solution for 12 hours, and where the trehalose solution is then drained away, but not rinsed away and not blotted away with a sponge or towel, it is the case that the trehalose solution has been “reduced.” The solution has been reduced because the small amount of trehalose that adheres to the surface of the meat, or that is associated with the surface of the meat, is not sufficient to significantly influence the properties of the meat, when compared to the original 500 mL of trehalose solution. In this context, the influence of the 500 mL of trehalose solution for a naïve sample of meat is set at 100%. And in this context, the influence of the amount of adhering trehalose solution, following draining, can be applied to a naïve sample of meat, where this trehalose sample influences the properties of the naïve sample of meat by less than 20%, by less than 10%, by less than 5%, by less than 1%.

This concerns the nomenclature of solutions, such as a solution containing a first concentration of trehalose. This particular solution can be called, “Solution A.” Where meat is soaked in Solution A, it may be the case that the composition of this solution is changed, for example, by release of salts from the meat into Solution A, or by absorption of solutes from Solution A into the meat. By definition, even after contract of Solution A with the meat, the solution is by definition still called, “Solution A.” In other words, at least in the context of meat soaking, Solution A that has been used for soaking is still called, “Solution A.” This definition avoids the cumbersome nomenclatures, such as, “used Solution A.”

“Weight loss” or “fluid loss” can be determined, without implying any limitation, by cutting a piece of meat into two even-sized pieces, and using one of these pieces for dipping or soaking in an experimental trehalose solution, and by using the other piece for dipping or soaking in a control solution (e.g., zero trehalose). The “weight loss” or “fluid loss” can be determined by comparing the data from the two pieces. Alternatively, “weight loss” or “fluid loss” can be determined by cutting a piece of meat into four even-sized pieces, and using two of these pieces for the experimental trehalose solution, and using the other two pieces for the control solution. In this case, the “weight loss” or “fluid loss” is determined from the average found for each group. In another alternative procedure, the meat can be cut into six even-sized pieces, with three pieces used for the experimental solution and three pieces for the control solution. In this case, the “weight loss” or “fluid loss” is determined from the average found for each group.

The triple point of a substance is the temperature and pressure at which the three phases (solid, liquid, gas) of that substance coexist in thermodynamic equilibrium.

### DETAILED DESCRIPTION OF THE DISCLOSURE

The disclosure encompasses methods, and compositions prepared by methods, that reduce water loss from a matrix, including from a protein-comprising matrix. Relevant compositions that comprise protein-containing matrices include meat, plant products, microbial products, e.g., yeast cake, products of fermentation, as well as tissues intended for transplant, grafting, tissue culture, or cell culture, including, but not limited to, tissues intended for medical, veterinary, agricultural, and research purposes. Also relevant and encompassed, are protein-containing products that have an exogenous semi-permeable membrane, such as sausage (see, e.g., Liu et al (2007) Meat Sci. 75:196-202). Unless specified otherwise, explicitly or by the context, “meat” encompasses, but is not limited to, beef, poultry, pork, fish, and meat of invertebrates, such as shellfish or insects, and any combination thereof. The present disclosure, without implying any limitation, also encompasses methods that can be used with plants, fungi, microbes, and synthetic compositions that contain a solute (e.g., protein) and water, for example, compositions that comprise synthetic protein, e.g., textured soy products or textured seafood products (e.g., surimi). Disclosure also provides methods and compositions for reducing water loss in fruits and vegetables (see, e.g., Embuscado and Huber (2010) Edible Films and Coatings for Food Applications, Springer, New York, pages 5-11, 48). The disclosure also encompasses methods that are not used as a food source, such as compositions that comprise natural and synthetic matrices, fabrics, nanotube-based structures, as well as medicinals and medical devices, such as pills, timed-release pills, and implants.

In embodiments, the volume of biological sample, tissue sample, organ sample, packed cell volume of a sample of cells, or meat sample, is about 10%, about 20%, about 30%, about 40%, about 50%, about 60%, about 70%, about 80%, about 90%, or about 100% (equal volume) to the volume of the soaking solution. In other embodiments, the volume of biological sample, tissue sample, organ sample, packed cell volume of a sample of cells, or meat sample, is about 1.0 times (equal volume), 1.5 times, 2.0 times, 3.0 times, 4.0 times, 5.0 times, 10 times, 15 times, 20 times, and the like, the volume of the soaking solution. Multiple soaking solutions, that is, with changes to fresh soaking solution, can be used, where a total of two, three, four, five, six, and the like, soaking solutions are used. Without implying any limitation, the sample can be exposed to fluid by using continuous flow or perfusion, for example, where one “sample volume” of fluid passes around the sample per second, per 10 sec, per 20 sec, per 60 sec, per 5 minutes, per 10 minutes, per 20 minutes, per hour, per two hours, per five hours, per ten hours, and the like.

Soaking or exposure time can be, for example, about 10 seconds, about 20 sec, about 40 sec, about 60 sec, about 2 minutes, about 4 min, about 8 min, about 10 min, about 15 min, about 20 min, about 40 min about 60 min, about 2 hours, about 4 h, about 6 h, about 8 h, about 10 h, about 12 h, about 14 h, about 16 h, about 18 h, about 20 h, about 24 h, about 30 h, 36 h, about 42 h, about 48 h, about 3 days, about 4 days, about 7 days, about 14 days, and the like. In embodiments, soaking can be for any range or time-frame between these times.

In embodiments, temperature for contacting (or treatment, dipping, or soaking) is the same (or about the same as) (or above) temperature used for storage, is the same as (or about the same as) (or above) the triple point for the matrix being treated, is the same as (or about the same as) (or above) the freezing point for the matrix being treated. In embodiments, temperature for contacting (or treatment, dipping, or soaking) is about 1 degree C. higher, about 2, about 3, about 4, about 5, about 6, about 7, about 8, about 9, about 10, about 15, about 20, about 25, about 30, about 35, about 40, about 50, about 60, about 70 degrees, about 80 degrees, about 90 degrees, and the like, higher than the temperature used for storage, than the triple point of the matrix being treated, or than the freezing point of the matrix being treated, and the like. In embodiments, for example, for tissues intended for transplant, temperature for contacting and temperature for subsequent storage, are both about 0 degrees C., both about 1 degree C., both about 2 degrees C., both about 3 degrees C., both about 4 degrees C., both about 5 degrees C., and so on.

Where reference is to properties of the matrix, in this context this means the matrix prior to treatment with trehalose, or with trehalose derivative or, if indicated expressly or by context, prior to treatment with any compound or composition.

The present disclosure provides a composition that comprises muscle fibers, composition that comprises a protein-containing matrix, meat, and the like, where the content of trehalose therein is as follows. For convenience, but without implying any limitation, the content is expressed in terms of 100 grams of meat. What is provided is: 0.005-0.01 mg trehalose/100 g meat; 0.01-0.05 mg trehalose/100 g meat; 0.05-0.10 mg trehalose/100 g meat; 0.1-0.5 mg trehalose/100 g meat; 0.5-1.0 mg trehalose/100 g meat; 1-2 mg trehalose/100 g meat; 2-5 mg trehalose/100 g meat; 5-10 mg trehalose/100 g meat; 10-20 mg trehalose/100 g meat; 20-50 mg trehalose/100 g meat; 50-100 mg trehalose/100 g meat; 100-200 trehalose/100 g meat; 200-500 mg trehalose/100 g meat; 0.5-1.0 grams trehalose/100 g meat; 1-2 g trehalose/100 g meat; 2-5 g trehalose/100 g meat, 4-6 g trehalose/100 g meat; 6-8 g trehalose/100 g meat; 8-10 g trehalose/100 g meat; 10-12 g trehalose/100 g meat; 12-14 g trehalose/100 g meat; 14-16 g trehalose/100 g meat; 16-18 g trehalose/100 g meat; 18-20 g trehalose/100 g meat, and the like. Also provided is meat where the trehalose concentrations are any combination of the above ranges. Exclusionary embodiments, which can exclude meat containing any of the above ranges, are also provided.

The following concerns the amount of trehalose per 100 grams of meat. Note that 0%, 5%, 10%, 15% trehalose is equivalent to 0 gms/100 ml, 5 gms/100 ml, 10 gms/100 ml or 15 gms/100 ml equilibrated with the meat, respectively. With equilibration of trehalose, as provided by a trehalose solution, with a meat, the amount of trehalose per 100 grams of meat are expected to be as follows, to provide non-limiting calculations. Where trehalose solution contains 5% trehalose, after equilibration meat is expected to contain 2.9 grams trehalose/100 grams meat. Where trehalose solution contains 10% trehalose, after equilibration meat is expected to contain 5.8 grams trehalose/100 grams meat. Where trehalose solution contains 15% trehalose, after equilibration meat is expected to contain 8.7 grams trehalose/100 grams meat. Trehalose concentration in a biological matrix, in muscle fibers, in meat, and the like, can be determined by extraction followed by analysis with high pressure liquid chromatography (HPLC), mass spectrometry, and so on. Alternatively, during treatment with trehalose solution, the solution can be spiked with radioactive trehalose. Following treatment, the radioactive trehalose can be extracted and measured by liquid scintillation spectrophotometry. The amount of extracted radioactive trehalose directly corresponds to the non-radioactive trehalose.

Other embodiments provide trehalose in distilled water, filtered water, sterilized water, tap water, trehalose in salt aqueous solution, trehalose in buffer (e.g., phosphate, histidine, or another amino acid), trehalose in combination with hydroxyl starch (see, e.g., U.S. Pat. No. 7,863,260 issued to Boll et al, and U.S. Pat. No. 5,502,043 issued to Weidler et al, which are incorporated herein by reference), or any combination of the above. Salt aqueous solutions encompass, e.g., sodium chloride, physiological saline, potassium chloride, sodium phosphate, potassium phosphate, soy sauce, and any combination thereof.

### Exclusionary Embodiments

In some non-limiting aspects, what can be excluded from compositions, reagents, methods, and the like, is any solution that contains gluconate, raffinose, sulfate, adenosine, glucose, glutathione, protease inhibitor, dimethylsulfoxide (DMSO), or any combination thereof. What can be excluded is any solution that contains greater than 0.5 mM gluconate, glucose, sulfate, or other small molecule, or any cation or anion, greater than 1.0 mm, greater than 10 mM, greater than 50 mM, greater than 100 mM, or greater than 200 mM gluconate, glucose, sulfate, or other small molecule, or any cation or anion. In other exclusionary embodiments, what can be excluded is any composition, reagent, or related method, that contains greater than 50 mM trehalose, greater than 100 mM, 200 mM, greater than 300 mM, greater than 400 mM, greater than 500 mM, greater than 600 mM, greater than 700 mM, greater than 800 mM, greater than 900 mM, greater than 1,000 mM trehalose, and the like. In some embodiments, the excluded small molecule, anion, or cation, is one that is synthetic, one that is added, one that is purified, or one that is naturally occurring in the composition.

What can be excluded is any method, or any step within a method, that uses freezing, that freezes an organ or tissue, or that freezes a cell or a plurality of cells.

In other exclusionary embodiments, the present disclosure provides reagents, compositions, and related methods, where trehalose is used at, or where trehalose is used only at, or where trehalose is used in a range that excludes, 0-5 mM trehalose, 5-10 mM, 10-20 mM, 0-25 mM, 25-50 mM, 50-100 mM, 75-125 mM, 100-150 mM, 125-175 mM, 150-200 mM, 175-225 mM, 200-250 mM, 225-275 mM, 250-300 mM, 275-325 mM, 300-350 mM, 325-375 mM, 350-400 mM, 375-425 mM, 400-450 mM, 425-475 mM, 450-500 mM, 475-525 mM, 500-550 mM, 525-575 mM, 550-600 mM, 575-625 mM, 600-650 mM, 625-675 mM, 650-700 mM, 675-725 mM, 700-750 mM, 725-775 mM, 750-800 mM, 775-825 mM, 800-850 mM, 825-875 mM, 850-900 mM, 875-925 mM, 900-950 mM trehalose, and the like. Also encompassed is any combination of the above ranges, such as 200-300 mM trehalose, or 200-475 mM trehalose, and so on. In other exclusionary embodiments, what is provided is a solution containing trehalose that does not include one or more of calcium ions, sulfate ions, magnesium ions, phosphate ions, potassium ions, chloride ions, sodium ions, and so on. Also, the present disclosure provides compositions, reagents, and methods, that include less than 1.0 mM of one or more of each of the above ions, less than 0.5 mM, less than 0.1 mM, less than 0.05 mM, less than 0.01 mM, of each of the above ions.

In exclusionary embodiments, methods and related compositions encompasses trehalose solution, where the solution does not contain more than 0.0 mM, 0.05 mM, 0.10 mM, 0.2 mM, 0.5 mM, 1.0 mM, 2.0 mM, 5.0 mM, 10 mM, 20 mM, 50 mM, 100 mM, or 200 mM salt, where the solution does not contain more than 0.0 mM, 0.05 mM, 0.10 mM, 0.2 mM, 0.5 mM, 1.0 mM, 2.0 mM, 5.0 mM, 10 mM, 20 mM, 50 mM, 100 mM, or 200 mM solute (other than trehalose), where the solution does not contain more than 0.0 mM, 0.05 mM, 0.10 mM, 0.2 mM, 0.5 mM, 1.0 mM, 2.0 mM, 5.0 mM, 10 mM, 20 mM, 50 mM, 100 mM, or 200 mM buffer, where the solution does not contain more than 0.0 mM, 0.05 mM, 0.10 mM, 0.2 mM, 0.5 mM, 1.0 mM, 2.0 mM, 5.0 mM, 10 mM, 20 mM, 50 mM, 100 mM, or 200 mM betaine or tremethylamino oxide (TMAO), dimethylsulfoxide (DMSO), glycerol, ethanol, methanol, or propanediol, amino acid (referring to any kind of amino acid), or carbohydrate (other than trehalose). In exclusionary embodiments, the present disclosure excludes a protocol, procedure, or method, that encompasses cooking. In other words, what can be excluded, is a procedure that involves contacting a protein-containing matrix, e.g., meat, with trehalose, and that further includes cooking.

The present disclosure provides, without implying any limitation, a solution comprising trehalose and one or more of, or all of, solutes that are NaCl, KCl, Na₂HPO₄, KH₂PO₄, CaCl₂, MgSO₄, and NaHCO₃. What is also provided is a solution that comprises, a solution comprising trehalose and one or more of, or all of, solutes that are NaCl, KCl, Na₂HPO₄, KH₂PO₄, and NaHCO₃, but not calcium ions and not magnesium ions. Also provided is a solution comprising trehalose and one or more of, or all of, that are 0.137 mM NaCl, 5.4 mM KCl, 0.25 mM Na₂HPO₄, 0.44 mM KH₂PO₄, 1.3 mM CaCl₂, 1.0 mM MgSO₄, and 4.2 mM NaHCO₃. Moreover, what is also provided is a solution comprising trehalose and one or more of, or all of, that are about 0.137 mM NaCl, about 5.4 mM KCl, about 0.25 mM Na₂HPO₄, about 0.44 mM KH₂PO₄, about 1.3 mM CaCl₂, about 1.0 mM MgSO₄, and about 4.2 mM NaHCO₃. In this context, the term “about” can be plus or minus 10%, plus or minus 20%, plus or minus 50%, plus or minus 100% (plus 100% is 2-fold greater), plus or minus 200% (plus 200% is 3-fold greater), plus or minus 300%, plus or minus 400%, and so on. The skilled artisan understands that a value that is minus 100% of a specific amount is zero, and that a value that is minus 200% of a specific amount is less than zero (and thus should be set to “zero”).

The present disclosure also provides a solution containing trehalose with one or more of sodium, potassium, calcium, magnesium, chloride, bicarbonate, phosphate, and sulfate, or alternatively, a solution containing trehalose that excludes one or more of sodium, potassium, calcium, magnesium, chloride, bicarbonate, phosphate, and sulfate. The solution can contain trehalose with one or more of sodium (142 mEq/L), potassium (5 mEq/L), calcium (5 mEq/L), magnesium (2 mEq/L), chloride (103 mEq/L), bicarbonate (26 mEq/L), phosphate (2 mEq/L), and sulfate (1 mEq/L). Also, the solution can contain trehalose with one or more of sodium (plus or minus 20% of 142 mEq/L), potassium (plus or minus 20% of 5 mEq/L), calcium (plus or minus 20% of 5 mEq/L), magnesium (plus or minus 20% of 2 mEq/L), chloride (plus or minus 20% of 103 mEq/L), bicarbonate (plus or minus 20% of 26 mEq/L), phosphate (plus or minus 20% of 2 mEq/L), and sulfate (plus or minus 20% of 1 mEq/L). Furthermore, solution can contain trehalose with one or more of sodium (plus or minus 80% of 142 mEq/L), potassium (plus or minus 80% of 5 mEq/L), calcium (plus or minus 80% of 5 mEq/L), magnesium (plus or minus 80% of 2 mEq/L), chloride (plus or minus 80% of 103 mEq/L), bicarbonate (plus or minus 80% of 26 mEq/L), phosphate (plus or minus 80% of 2 mEq/L), and sulfate (plus or minus 80% of 1 mEq/L).

In embodiments, trehalose solution can also include one or more organic acids, such as glutamic acid, gluconic acid, tartaric acid, maleic acid, or aspartic acid. Also, trehalose solution can contain protein, such as lactalbumin, albumin, ovalbumin, casein, soy protein, gelatin, or partial digests thereof, and so on. Salts, acids, proteins, and other reagents can be obtained from, for example, Sigma Aldrich (St. Louis, Mo.); Harlan Laboratories, Indianapolis, Ind.).

In another aspect, the present disclosure provides a solution containing trehalose, that also contains magnesium at 1.3-2.2 mEq/L; potassium at 3.5 mEq/L to 5.0 mEq/L; calcium at 9.0 mg/dL to 10.5 mg/dL; phosphorus at 3.0 to 4.5 mg/dL.

In another aspect, what is provided is a frozen composition that, when thawed, provides above solution. Also provided, is a powdered composition that when dissolved in water, provides above solution. Moreover, what is provided is a beaded composition that, when dispersed or dissolved in water, provides above solution.

In another aspect, the present disclosure provides a solution with trehalose with one or more of 1-5 mM glucose, 5-10 mM glucose, 10-20 mM glucose, 20-50 mM glucose, 50-100 mM glucose, 100-200 mM glucose, 1-5 mM glutamine, 5-10 mM glutamine, 10-20 mM glutamine, 20-50 mM glutamine, 50-100 mM glutamine, 100-200 mM glutamine, 1-5 mM glycerol, 5-10 mM glycerol, 10-20 mM glycerol, 20-50 mM glycerol, 50-100 mM glycerol, 100-200 mM glycerol, and so on.

Disclosure provides compositions that resist microbial breakdown or that are not broken down by microbial enzymes, e.g., by using a trehalose-based composition. Also, disclosure provides compositions that reduce or minimize microbial growth during storage, e.g., by a step that dries a tissue prior to storage. Moreover, disclosure provides compositions that can be supplemented with an emulsion, suspension, colloid, or gel, and such, wherein stability of the emulsion, suspension, colloid, or gel, depends on or requires a specific water concentration, and where stability can be optimally attained by drying tissue prior to storage.

In comparative embodiments, a preferred solution for soaking or dipping can include trehalose, where results from use of this solution can be compared to results where the trehalose is replaced with a soaking or dipping solution that contains a lower concentration of trehalose, e.g., 50%, 25%, 10%, 5%, or 0% trehalose (control solutions). Comparative results can also be acquired where the trehalose is replaced with another carbohydrate, for example, a monosaccharide, a disaccharide, a trisaccharide, or with glycerol, sucrose, lactose, galactose, sorbitol, and the like (see, e.g., carbohydrates disclosed in U.S. Pat. No. 5,229,276 issued to Sugitani et al; U.S. Pat. No. 5,262,191 issued to Chakraborty, U.S. Pat. No. 7,960,176 issued to Louvet et al, which are each incorporated by reference in their entirety). The trehalose and comparator carbohydrate can be used, in the solution, at equivalent weight percent, molarity, molality, or osmotic strength, or can be adjusted and used to give equivalent freezing point. Exclusionary embodiments are also provided, e.g., where the disclosure excludes use of glycerol, sucrose, lactose, galactose, and the like, in the context of a comparator, or in the context of a composition that is not a comparator (see, e.g., above-cited patents, which are incorporated by reference). In other exclusionary embodiments, the disclosure provides methods and composition, that exclude freeze-drying, that exclude desiccating, that exclude glass transition temperature, that exclude heat-drying, that exclude powdering, that exclude kneaded meat, that exclude emulsifier, that excluded added or exogenous phosphate, that exclude added or exogenous polyphosphate, or that exclude polyethylene glycol (PEG). In embodiments, what is excluded is method or composition that consists of cultured cell, that comprises cultured cells, or that is a composition comprising an organ or tissue where over over 20%, over 30%, over 40%, over 50%, over 60%, over 70%, over 80%, over 90%, over 95%, of the cells in the composition are free and do not adhere to each other in a stable manner. Without implying any limitation, “organ or tissue,” in some embodiments, excludes biological substances that are ground, finely chopped, or minced.

### Hydroxyethyl Starch

Hydroxyethyl starch (HES) can be included, as a component, of trehalose solutions. HES is a class of synthetic colloids that are derived from amylopectin. Polymerized units of D-glucose are joined mostly at 1-4 linkages. The degree of branching is approximately one branch (1-6 linkage) for every 20 units of glucose. This degree of branching is abbreviated as 1:20. Hydroxyethyl groups are added to increase solubility and reduce hydrolysis. Hydroxyethyl starch can be classified according to its molecular weight and by molar substitution. Hydroxyethyl starch has been classified as, hetastarch, hexastarch, pentastarch, and tetrastarch, as detailed below.

In embodiments, the present disclosure provides hydroxyethyl starch, for example, hetastarch, at a final concentration of 0.25-0.5%, 0.5-1.0%, 1.0-1.5%, 1.5-2.0%, 2.0-2.5%, 2.5-3.0%, 3.0-3.5%, 3.5-4.0%, 4.0-4.5%, 4.5-5.0%, 5.0-5.5%, 5.5-6.0%, 6.0-6.5%, 6.5-7.0%, 7.0-7.5%, 7.5-8.0%, 8-10%, 10-12%, 12-14%, 14-16%, 16-18%, 18-20%, and the like, or any combination thereof, for example, 2.0-6.0%.

Preparations with a molecular weight of 670 kDa (0.75), 600 kDa (0.7), and 480 kDa (0.7) are classified as hetastarch. The molar substitution is indicated in parenthesis. Hexastarch can have a molecular weight of 200 kDa and molar substitution of 0.62. Pentastarch can have a molecular weight of 200 kDa or 70 kDa, each with a molar substitution of 0.5. Tetrastarch has a molecular weight of 130 kDa and molar substitution of 0.42 (Boldt (2009) Anesth. Analg. 108:1574-1582).

### Measuring Parameters of Meat

In comparison embodiments, what can be compared between trehalose-treated tissue and control tissue, is fluid loss, water loss, protein loss, weight loss, histology of treated tissues or cells, viability or function of tissue where tissue is transplanted to a subject (e.g., transplanted topically, intravenously, or viscerally, and the like). What can also be compared is muscle fiber fragmentation, myofibril fragmentation index, myofibril fragmentation index, sarcomere length, meat tenderness, sensory evaluations of raw meat or cooked meat, imaging, or shear force (e.g., as determined by Warner-Bratzler shear force). See, e.g., Nakai et al (1995) Biosci. Biotech. Biochem. 59:2255-2258; Davis et al (1970) J. Animal Sci. 49:103-114; Calkins and Davis (1980) J. Animal Sci. 50:1067-1072; Dosler et al (2007) Acta Agriculturae Slovenica 1:5-16; Koohmaraie et al (1988) J. Food Sci. 53:407-410; U.S. Pat. No. 6,042,855 issued to Beitz et al; U.S. Pat. No. 5,968,565 issued to Owens et al, and US 20040125987 of Haagensen, each of which are hereby incorporated herein by reference in its entirety.

### Muscle Fiber Fragmentation Embodiments

In muscle fibril embodiments, disclosure provides meat that is cut or sliced at a thickness of about 2.5 micrometers (μm), 5 μm, 10 μm, 20 μm, 40 μm, 80 μm, 100 μm, 120 μm, 140 μm, 160 μm, 180 μm, 200 μm, 220 μm, 240 μm, 260 μm, 280 μm, 300 μm, 350 μm, 400 μm, and the like. For any given sample that is cut at the thickness, disclosure provides a viewing field of about 25 square micrometers (μm²); 100 μm²; 400 μm²; 900 μm²; 2,500 μm²; 10,000 μm²; and the like. For any given viewing field, at any given slice thickness, disclosure provides a method, and compositions provided by the method, wherein the field has at least one fracture that is roughly perpendicular to the longitudinal axis of muscle fiber, at least 2 fractures, at least 3 fractures, at least 4 fractures, at least 5 fractures, at least 6 fractures, and the like. Roughly perpendicular can mean within 5 degrees, within 10 degrees, within 20 degrees, or within 30 degrees, and the like, of a line that is perpendicular to the longitudinal axis. Also, for any given viewing field, at any given slice thickness, disclosure provides a method, and compositions provided by the method, wherein the field has at least one partial fracture that is roughly perpendicular to the longitudinal axis of muscle fiber, at least 2 partial fractures, at least 3 partial fractures, at least 4 partial fractures, at least 5 partial fractures, at least 6 partial fractures, and the like. Moreover, for any given viewing field, at any given slice thickness, disclosure provides a method, and compositions provided by the method, wherein the field has at least one partial or full fracture that is roughly perpendicular to the longitudinal axis of muscle fiber, at least 2 partial or full fractures (that is, any combination), at least 3 partial or full fractures, at least 4 partial or full fractures, at least 5 partial or full fractures, at least 6 partial or full fractures, and the like. In embodiments that involve comparison, trehalose-treated tissue, e.g., muscle, as compared to control tissue, results in increase in fragmentation, according to, but not limited to, the various number of fractures that are disclosed above.

Without implying any limitation, method that uses trehalose solution results in weight loss during thawing, due to drip, that is less than 99%, less than 95%, less than 90%, less than 85%, less than 80%, less than 75%, less than 70%, less than 60%, less than 50%, less than 40%, less than 30%, less than 20%, less than 10%, less than 5%, that when compared to weight loss during thawing, due to drip, when compared to loss with comparator solution that does not contain trehalose (set at 100%). In cooking embodiments, method that uses trehalose solution results in weight loss during thawing, due to drip, that is less than 99%, less than 95%, less than 90%, less than 85%, less than 80%, less than 75%, less than 70%, less than 60%, less than 50%, less than 40%, less than 30%, less than 20%, less than 10%, less than 5%, that when compared to weight loss during cooking (without taking into account weight loss during any thawing/drip), when compared to loss using comparator solution that does not contain trehalose (set at 100%).

Perfusion embodiments are provided, for example, where a tissue or organ are perfused with a trehalose solution. Perfusion can be in place of soaking or dipping, or in addition to soaking or dipping. Methods for perfusion, for example, for heart, lung, liver, kidney, pancreas, or pancreatic islets, are available (see, e.g., Bonnevie-Nielsen et al (1983) Endocrinology 112:1049-1056; Lai et al (2007) Diabetes 56:107-112; Buehring et al (1972) Biochim. Biophys. Acta 279:498-512). In excluding embodiments, disclosure excludes methods and compositions injected, infused, soaked, dipped, or perfused in a solution that comprises calcium chloride, or excludes methods comprising administration of vitamin D.

The present disclosure provides methods and compositions, in non-limiting embodiments, that encompass organs or tissues for transplantation, that is, for transplanting the entire organ or tissue, or for transplanting cells that are eventually harvested from organ or tissue, where organ or tissue is subjected to a pre-determined soaking time in trehalose solution, and subsequently stored at sub-zero temperature that does not result in freezing of organ or tissue, or alternatively, subsequently stored at sub-zero temperature that does freeze the organ or tissue, or alternatively, stored at triple point, or in another aspect, stored at a temperature above zero that does not result in freezing.

In some embodiments, disclosure provides an organ or tissue that is human, or that is of human origin, and therefore cannot be used for cooking or for food preparation. What is also provided are methods, and related compositions, that includes, or that excludes one or more or all cryoprotectants. Also, what is provided are methods, and related compositions, that includes, or that excludes one or more or all lyoprotectants (see, e.g., U.S. Pat. No. 6,919,172 issued to DePablo et al, and U.S. Pat. No. 7,960,098 issued to Roy et al, which are incorporated herein by reference). In exclusionary embodiments, method or composition excludes lyophilization, excludes freeze-drying, or excludes dessication. These encompass fish proteins, certain polymers, skim milk, glycerol, dimethyl sulfoxide (DMSO), propanediol, ethylene glycol, and disaccharides, such as trehalose. Also encompassed, are embodiments that include trehalose and a polymeric gelling agent, such as carboxymethylcellulose or carboxyethylcellulose, or that include trehalose but exclude a gelling agent. Method, or composition, in embodiments excludes fish, excludes shellfish, excludes preparations of microorganisms, such as bacterial preparations intended for long-term storage.

The disclosure provides methods, and related compositions, that where the starting weight of tissue or organ is set at 100%, and where final weight is at least 99%, at least 98%, at least 97%, at least 96%, at least 95%, at least 90%, at least 85%, at least 84%, at least 83%, at least 82%, at least 81%, at least 80%, at least 75%, at least 70%, at least 65%, at least 60%, and the like, that of the starting material. Transition from starting material can involve, for example: (1) Transition of removing organ or tissue from a body, cooling to below zero degrees C., and warming to above zero degrees C.; (2) Transition of removing organ or tissue from a body, and cooling to below zero degrees C.; (3) Transition beginning with organ or tissue at below zero degrees C., and warming to above zero degrees C., and the like. In some aspects, the measured weight is that of water only. In other aspects, the measured weight is the combination of water with any solutes dissolved in the water. Also, the measured weight can be the combination of water with any solutes, precipitates, or particulate matter suspended in the water.

In embodiments, methods and related compositions encompass, comprise, or consist essentially of, pancreas, islets of Langerhans, adrenal gland, liver, lobe of liver, isolated blood vessel, tissue for saphenous graft, heart valve, tissue for use in coronary bypass surgery, eye, lens of eye, retinal tissue, nerve tissue, muscle tissue, muscle, sphincter muscle, skeletal muscle, smooth muscle, ovary, ovarian cortex, testicle, endocrine gland or tissue, exocrine gland or tissue, adrenal gland, thyroid gland, pituitary gland, kidney, renal tissue, segment of or entirety of esophagus, stomach, duodenum, jejunum, ileum, large intestines, or colon, urinary bladder, heart, cardiac tissue, heart valve, brain or brain tissue, lung or lung tissue, for example, for hepatitis C virus (HCV) patients, skin or epidermis, for example, for burn patients, bone, bone marrow, spleen, immunological tissue, lymphatic tissue, lymph node, hematopoietic tissue, one or more teeth, dental tissue, cartilage, ligaments, tendon, meniscus, intervertebral discs, breast, mammary tissue, fetus, fetal tissue, embryo, egg, fertilized egg, duct or ducts, vascular tissue, tumor or tumors, precancerous tissue, and the like. In one aspect, disclosure encompasses one or more cells, for example, one or more stem cells, one or more mesenchymal stromal cells (MSCs), one or more mesenchymal stem cells (MSCs), one or more hematopoietic cells, and so on. In addition, disclosure encompasses method and related composition, that includes a membrane permeabilizing agent, e.g., membrane-permabilizing polymer, or that excludes a membrane-permeabilizing agent, e.g., membrane-permeabilizing polymer.

What is provided, for example, is a method for treating one or more of the above organs or glands with trehalose, allowing partial or full equilibration of the trehalose solution with the organ, and then storing on ice, storing in a refrigerator, freezing, treating with a cryoprotectant and then freezing. Also provided are organs, glands, and the like, that contain trehalose, where the trehalose is introduced by method of the present disclosure.

In another aspect, without implying any limitation, disclosure excludes samples that comprise free cells, e.g., cells in monolayer, cells in suspension, loosely adherent cells (adherent to each other), or cells in the process of migrating or chemotacting from one part of a tissue to another part of the tissue. For example, disclosure excludes a composition comprising tissue or organ and one or more free cells, where over 10% of the cells in the entire composition are free cells, or where 20%, 40%, 60%, 80%, 90%, 95%, or 99% are free cells. Also, without implying any limitation, disclosure excludes methods that kill at least 10% of cells, at least 20% of cells, at least 40% of cells, at least 60% of cells, at least 80% of cells, at least 95% of cells, in an organ or tissue. For example, what may be excluded is method where trichloroacetic acid (TCA) is added to organ or tissue.

In food embodiments, what is encompassed is methods, and related compositions, to reduce water loss from a food, such as raw meat, or raw organ meat. Food, meat, organ, or non-food tissue or organ, may be stored frozen for at least 1 day, at least 2 days, at least one week, at least two weeks, at least one month, at least two months, at least five months and so on. Storage can be, for example, at about minus 50 degrees C. (° C.), about minus 45° C., about minus 40° C., about minus 35° C., about minus 30° C., about minus 25° C., about minus 20° C., about minus 15° C., about minus 10° C., or about minus 5° C. The food, meat, organ, or non-food tissue or organ, can be subject to daily cycles of defrosting. In control or comparator embodiments, the food, meat, organ, or non-food tissue or organ, loses about 10% of its weight in water over a period of ten (10) months. Also, in control or comparator embodiments, the food, meat, organ, or non-food tissue or organ is stored in a container, e.g., a clear bag, and ice crystals visibly accumulate in the container during the storage period.

In embodiments of the present disclosure, the loss of water is less than 10% of the weight, less than 8%, less than 6%, less than 5%, less than 4%, less than 3%, less than 2%, less than 1.0%, less than 0.5%, less than 0.2%, and the like. In the present disclosure, ice crystals are reduced in size, number, total weight, or visibility, where reduction is to less than 80%, less than 60%, less than 50%, less than 40%, less than 30%, less than 20%, less than 10%, and so on.

In alternate embodiments, the entire period of time, over which daily defrosting cycles are carried out, is about one day, about two days, about three days, about four days, about five days, about six days, about one week, about two weeks, about one month, about 1.5 months, about two months, about five months, above ten (10) months, about 12 months, about 18 months, about 24 months, about 5 years, about 10 years, and so on.

Disclosure provides methods, and related compositions, for enhancing the quality of food, for example, the color, texture, moisture content, of meat. Color, discoloration, flavor quality, aroma, palatability, tenderness, and the like, can be determined, e.g., by trained visual panelists, using a multi-point scale, or by measuring metmyoglobin. See, e.g., Grobbel et al (2006) J. Anim. Sci. 84:694-701; Liu et al (1996) J. Anim. Sci. 74:117-126; Poste (1990) J. Anim. Sci. 68:4414-4420; Zuang and Savage (2008) J. Food Sci. 88:214-220; AMSA (1991) Guidelines for Meat Color Evaluation. Proc. Recip. Meat Conf. vol. 44. Am. Meat Sci. Assoc., Champaign, Ill.; AMSA (1995) Research guidelines for cookery, sensory evaluation, and instrumental tenderness measurements of fresh meat. Nat'l. Live Stock and Meat Board, Chicago, Ill.; CIE (1976) Suppl. No. 2 to CIE Publ. No. 15 (E-1.3.1) Commission Internationale de l'Eclairage, Paris, France). Moisture content can be measured, and methods for chilling meat are available (see, e.g., Jeong et al (2011) Poultry Sci. 90:687-693. Methods and equipment for assessing the quality of biological materials, and for processing biological materials, including meat, are available. See, e.g., U.S. Pat. No. 7,575,770 issued to Garwood; U.S. Pat. No. 8,012,521 issued to Garwood; U.S. Pat. No. 5,939,112 issued to Katayama and Katayama; each of which is incorporated by reference in its entirety.

In a non-limiting embodiment regarding the surface of meat, the quality of being dried can be determined by briefly (e.g., 1 second, 2 sec., 5 sec., or 10 sec.) applying a capillary tube to the surface of a meat sample. If the amount of liquid drawn up is minimal (e.g., less than 5 mm, less than 2 mm, less than 1 mm, less than 0.5 mm), then the surface of meat may be declared to be dried. Meat surface that is declared to be “dried” can be moist, or it can be drier than “moist.” Meat surface that is declared to be “dried” can also be not moist. Where organ, tissue, or meat, is dried, it can reside at ambient temperature in a dry or dried state, for example, for about 10 seconds, about 20 sec, about 1 minute, about 2 min, about 10 min, about one hour, about two hours, about five hours, and then placed in a freezer for storage (or placed in a water-impermeable compartment, e.g., plastic bag, and then placed in a freezer for storage). Drying meat surface, e.g., prior to freezing, can prevent excessive sweetness, that is, sweetness resulting at least in part from trehalose solution. Drying meat surface can also reduce the customer-aversion quality of a meat product that is accompanied by a pool of fluid, that is, pool resulting at least in part by trehalose solution. Trehalose resists breakdown by microbial enzymes. Also, trehalose fails to support growth of microbes, or poorly supports growth of microbes, e.g., in contrast to glucose.

Trehalose, salts, buffers, and other reagents, can be acquired from, for example, Sigma Aldrich (St. Louis, Mo.), Fischer Scientific (Hanover Park, Ill.); Hayashibara Biochemical Laboratories, Inc. (Okayama, Japan). Radioactive trehalose can be prepared (see, e.g., Stambuk et al (1993) Analyt. Biochem. 212:150-153). Present disclosure encompasses, without limitation, trehalose derivatives, both covalent and non-covalent, and trehalose derivatives, including derivatives that are methylated, acetylated, sulfated, glycosylated, oligomerized, and the like.

Freezers, temperature probes, pumps, rheometers (viscometers), pH meters, osmometers, and such, are available (Cole-Parmer, Vernon Hills, Ill.; Fischer Scientific, Hanover Park, Ill.; Whirlpool Corp., Benton Harbor, Mich.; Brookfield Engineering Laboratories, Middleboro, Mass.; Beckman Coulter, Brea, Calif.; Advanced Instruments, Norwood, Calif.).

Regarding the concentration of trehalose (or other additive, ion, or salt) in samples of organs or tissues, intracellular concentration, or interstitial fluid concentration, is between 20-40 nM, 40-60 nM, 60-80 nM, 80-100 nM, 100-200 nM, 200-400 nM, 400-600 nM, 600-800 nM, 800-1000 nM, 1-2 micromolar (μM), 2-4 μM, 4-6 μM, 6-8 μM, 8-10 μM, 10-20 μM, 20-40 μM, 40-80 μM, 80-100 μM, 100-200 μM, 200-400 μM, 400-600 μM, 600-800 μM, 800-1000 μM, 1-2 mM, 2-4 mM, 4-6 mM, 6-8 mM, 8-10 mM, 10-20 mM, 20-40 mM, 40-60 mM, 60-80 mM, 80-100 mM, 100-200 mM, 200-400 mM, 400-600 mM, 600-800 mM, 800-1000 mM, and the like. In another aspect, intracellular or interstitial concentration is at least 20 nM, 40 nM, 60 nM, 80 nM, 100 nM, 200 nM, 400 nM, 600 nM, 800 nM, 1000 nM, 2 micromolar (μM), 4 μM, 6 μM, 8 μM, 10 μM, 20 μM, 40 μM, 60 μM, 80 μM, 100 μM, 200 μM, 400 μM, 800 μM, 1000 μM, 2 mM, 4 mM, 6 mM, 8 mN, 10 mM, 20 mM, 40 mM, 60 mM, 80 mM, 100 mM, 200 mM, 400 mM, 600 mM, 800 mM, 1000 mM, and so on. Concentration can also be, e.g., at least 0.125%, 0.25%, 0.5%, 1.0%, 1.5%, 2.0%, 3.0%, 4.0%, 5.0%, 7.5%, 10%, 12.5%, 15%, and the like, on the basis of grams trehalose per gram tissue sample. Tissue sample, can take the form of entire cut of meat, as might be acquired from a butcher or grocery, or it can take the form of a sample from the outermost 1 mm of the meat, outermost 5 mm of the meat, outermost 10 mm of the meat, and so on.

### Hematoxylin

Hematoxylin is a dye that binds to nucleic acids by intercalative binding (Xu et al (2010) Nucleosides, Nucleotides and Nucleic Acids. 29:854-866). The skilled artisan can use the absorbance spectrum differences between free hematoxylin, and the complex of hematoxylin and nucleic acid, to determine the concentration of hematoxylin/nucleic acid complex. Absorption spectra of hematoxylin complexes, methods, and suppliers for hematoxylin, are available (see, e.g., Kiernan and Horobin (2010) Biotech. Histochem. 85:5-6; Smith (2010) Biotech. Histochem. 85:43-54; Gill (2010) Biotech. Histochem. 85:7-18; Kiernan (2006) Color Technol. 122:1-21; Bettinger and Zimmermann (1991) Histochemistry. 96:215-228). An increase in blue color due to hematoxylin staining by an increment of absorbance of about Abs.=0.05, representing 0.05 μM nucleic acid or histones, can represent a concentration of about 1.0 μM, about 5 μM, about 20 μM, about 100 μM nucleic acid or histones, about 0.5 mM nucleic acid or histones, about 2.0 mM nucleic acid or histones, and the like. The increase can compare staining of trehalose-treated tissue with and without hematoxylin. Alternatively, the increase in absorbance can compare hematoxylin-treated tissue (no trehalose), with hematoxylin-treated trehalose-treated tissue. The skilled artisan is able to estimate, by eye, the absorbance of a colored solution, or of a colored image from a microscope photograph, for any visible wavelength of light, where there is no need to refer to number corresponding to the wavelength of maximal absorbance. Where absorbance is determined by eye, the skilled artisan can estimate absorbance without reference to any calibrated color chart, however, calibrated color charts that disclose various absorbancies can be readily created by high school students with a year of training in chemistry. Hematoxylin has been used for quantitative staining of nucleic acids (see, e.g., Schulte and Fink (1995) Anal. Cell Pathol. 9:257-268). The present disclosure provides compositions comprising a matrix that comprises protein, compositions comprising meat, compositions comprising tissue, where the compositions were treated with trehalose, then subject to at least one freeze/thaw cycle, and where the presence of trehalose resulted in an increase in hematoxylin-staining material (located between myofibrils, or located between bundles, or both), and where the increase in material is at least by an absorbance of at least 0.01, at least 0.02, at least 0.05, at least 0.10, at least 0.15, at least 0.20, at least 0.25, at least 0.30, and the like.

### Examples

In the following examples, the trehalose that was used was trehalose dihydride.

An accelerated model of adverse conditions was used to demonstrate issues that might arise during one or more cycles of freezing and thawing. Variables included the high and low temperatures of the temperature range, and frequency of the freeze/thaw cycles. In one embodiment, treated meat samples were placed in a minus 40 degrees C. freezer for 24 hours, followed by room temperature for 6 hours, which was followed by 18 hours at 0.5 to 5.0 degrees C., in a refrigerator. This cycle was immediately followed by minus 40 degrees C. freezer for 24 h, room temperature for 6 h, which was followed by 18 hours at 0.5 to 5.0 degrees C., in a refrigerator.

Chicken breast fillet, pork chops, and London broil beef, were obtained from local suppliers and were cut in water. Each type of meat was cut into four even-sized pieces, and the weight was recorded. Each piece was immersed separately in either water or in test solution, e.g., trehalose or saline, for 12 h. The meat was removed from the water, and excess water was blotted off. Place each sample in a Ziploc® plastic bag. Weights were recorded. The weighed samples were set in a container, and placed in a freezer, where each sample was at the same level (same level relative to the floor of the freezer). The freezer (minus 40 degrees C.) was Puffer Hubbard Model #4017A-U-A, Harris Manufacturing Co., North Billerica, Mass. This freezer did not have a defrosting feature. Then, the following steps were used:

Repeat Steps 1 to 4 until a total of 14 days have passed.

Step 1. After 24 h in the freezer, remove the container bearing all of the samples. Take photographs of the samples and record the date. Thawing occurs when the meat is taken from the freezer and left in the refrigerator. Although the meat is completely thawed prior to 24 hours of incubation in the refrigerator, the time of 24 hours was used to standardize the procedure.

Step 2. Place all samples (still in the same container) in refrigerator.

Step 3. After in the refrigerator 24 h, then remove the container with all the samples, and take photos and record the date.

Step 4. Place samples, still in the same container, in the freezer.

As mentioned above, repeat Steps 1 to 4 until a total of 14 days have passed.

Step 5. After the last sample photos were taken, samples were removed from its bag, and the weight was recorded after removing excess ice from the sample. The ice is left in the bag. Replace sample in Ziploc® bag. Place all bags at room temperature until all the ice has melted, and pour fluid into clear plastic tube with graduated side (fluid from each bag), and record the volumes of the fluid. Alternatively, volume can be determined with a pipette.

Step 6. Place all weighed meat samples into the same Ziploc® bag, and place back in the refrigerator to thaw. After thawing, remove the meat samples from each bag, and pour excess fluid into graduated cylinder tubes (the tubes that held the ice that had melted), and record additional volumes.

Step 7. Label all meat samples, and place all meat samples on a pan with a grate, and then into a 350 degree oven for about 30 minutes. A thermometer was used to take interior temperature of the meat. After cooking, and cooling, take photos of each cooked meat sample, and weigh each sample.

Figures Disclosing Data from First Week of Freeze/Thaw Cycles

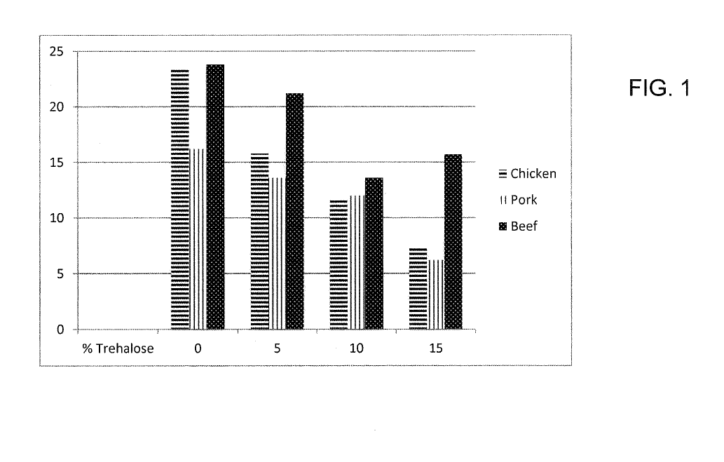

Regarding FIG. 1, the percent trehalose used in the experiment was 0%, 5%, 10%, or 15%, where the treated meat was poultry, pork, or beef. Within each triplet of bars in the histogram, the meat was poultry, pork, and beef, respectively. For the first triplet, 0% trehalose was used in the soaking solution. For the next triplet, 5% trehalose was used. For the next triplet, 10% trehalose was used. For the last triplet, 15% trehalose was used. For each type of meat, the following trend was demonstrated. Increasing the concentration of trehalose resulted in decreasing volumes of fluid lost. Maximal effect of trehalose occurred at about 10%, for beef, and at about 15%, for poultry and pork, for the range of trehalose concentrations used in this study. For each type of meat, there was a clear loss of weight from post-soaking weight to final weights, after three cycles of freeze/thaw. Regarding the three types of meat, increasing concentrations of trehalose had the most dramatic effect on reducing fluid loss from poultry.

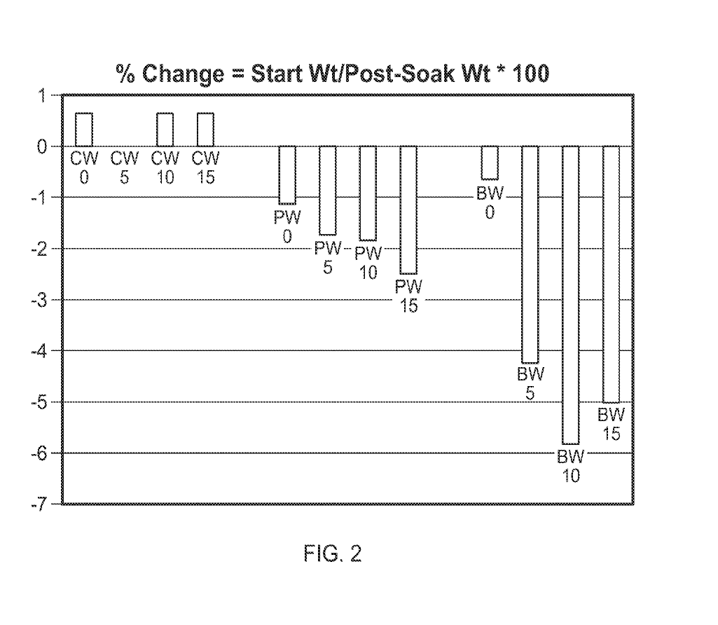

Regarding FIG. 2, what is shown is the change of weight during the initial soaking of meat in trehalose solutions (18 hours). Each series of four bars on the histogram refers to results, where the 18 h soak used 0%, 5%, 10%, and 15% trehalose. The weight of the chicken meat samples was not appreciably influenced. With pork, soaking resulted in a decrease in weight of the meat by about 1% to 2%. With beef, the weight was not appreciably changed with soaking in 0% trehalose, but with 5%, 10%, and 15%, trehalose, beef lost about 4% to 5% of its weight (FIG. 2).

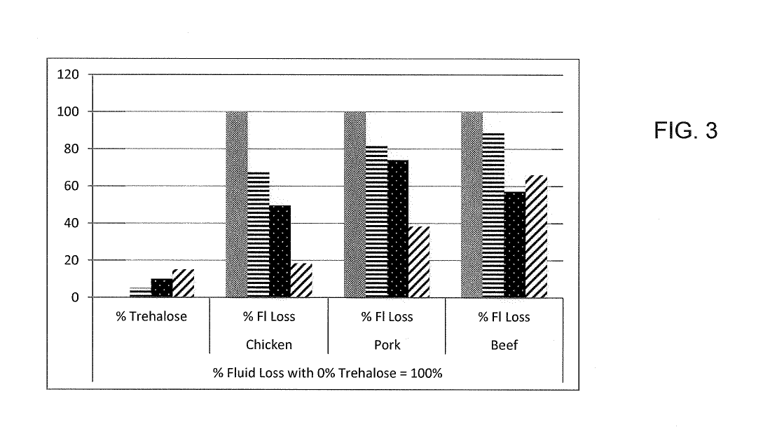

Regarding FIG. 3, what is shown is the same fluid loss data that is disclosed in FIG. 1, except that FIG. 3 segregates data according to the type of meat. Fluid lost with 0% trehalose, was set at 100% loss for each type of meat, respectively. The first group of bars in the histogram is the legend, indicating that the percent of trehalose used was 0%, 5%, 10%, or 15%. The next group of bars (four bars) shows fluid loss from chicken. The next group of bars (4 bars) is fluid loss from pork. The final group of bars (4 bars) reveals fluid loss from beef. Of the three types of meat that were treated with trehalose, chicken showed the greatest reduction in fluid loss. In this experiment, the maximal influence of trehalose was shown at 15% trehalose for chicken, at 15% trehalose for pork, and for 10-15% for beef.

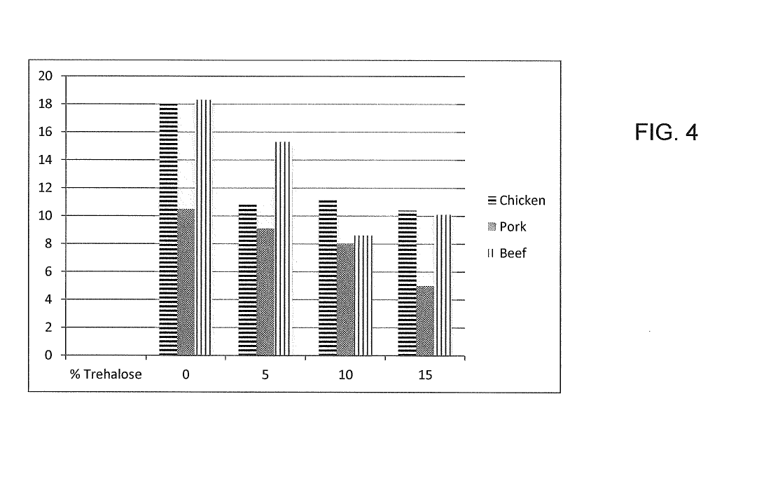

The next figure, FIG. 4, discloses weight loss (not fluid loss). Each triplet of bars in the histogram represents percent weight loss for the samples of chicken, pork, and beef, respectfully. The trends in weight loss are somewhat similar to the trends for fluid loss. For chicken, weight loss was 18% when the chicken had been soaked in 0% trehalose, where the weight loss was lesser (hovering at about 10-11% weight loss), where soaking had been in 5%, 10%, or 15% trehalose. For pork, weight loss was about 10% when the pork had been soaked in 0% trehalose, where this loss was progressively prevented with progressively increasing concentrations of trehalose. Thus, for pork, the weight loss was about 10%, about 9%, about 8%, and about 5%, where soaking was with 0%, 5%, 10%, or 15% trehalose, respectively. For beef, weight loss was 18% where the beef had been soaked in 0% trehalose, where some of this the weight loss was prevented where 5%, 10%, or 15% trehalose was used in soaking. Thus, for beef, the weight loss was about 18%, 15%, 8%, and 10%, where soaking was with 0%, 5%, 10%, or 15%, trehalose, respectively.

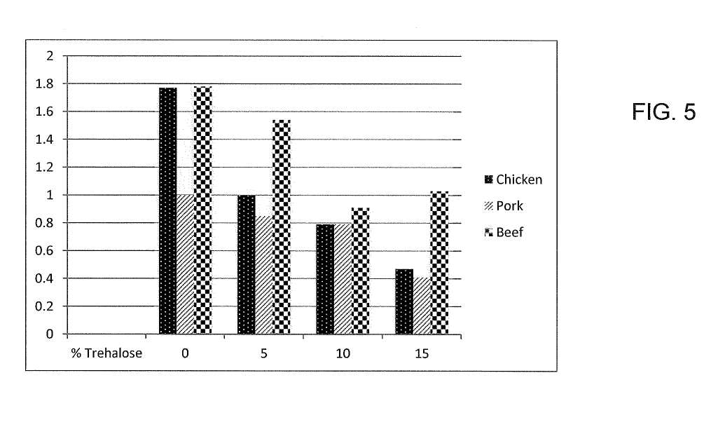

Regarding FIG. 5, what is shown is loss of water/10 grams of meat. Loss of water/10 g meat is shown where soaking was with 0%, 5%, 10%, and 15% trehalose. Each triplet of bars in the histogram refers to water loss for chicken, pork, and beef, respectively. For chicken treated with 0% trehalose, the loss was about 1.8 mL/10 grams of meat, while with 15% trehalose, water loss was only 0.47 mL/10 grams of meat. For pork treated with 0% trehalose, the loss was 1.0 mL/10 grams of meat, while with 15% trehalose, water loss was only 0.4 mL/10 grams of meat. For beef treated with 0% trehalose, the water loss was about 1.8 mL/10 grams of meat, while with 10% trehalose, water loss was about 0.9 mL/10 grams of meat.

Figures Disclosing Data from Second Week of Freeze/Thaw Cycles

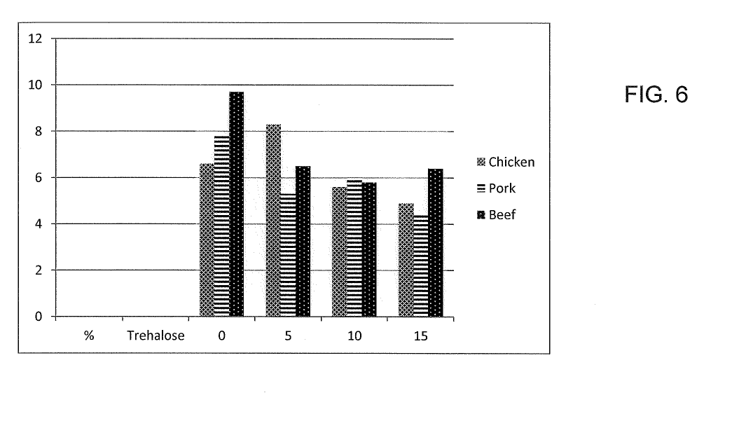

Between the first week (three freeze/thaw cycles) and the second week (three more freeze/thaw cycles), there was no re-exposure to trehalose. All samples were removed from the refrigerator. Liquid was in most of the sample bags. Fluid was removed by a pipette and the volume was recorded, and the meat sample was weighed. Samples of about 1-2 grams were taken using a no. 10 scalpel, and placed in formalin. FIG. 6 discloses the volume of fluid lost during the second week of freeze/thaw cycles. For chicken, 15% trehalose had a maximal effect on reducing fluid loss. For portk, 15% also had a maximal influence on reducing fluid loss. For beef, 10% haloesose had a maximal effect on minimizing fluid loss.

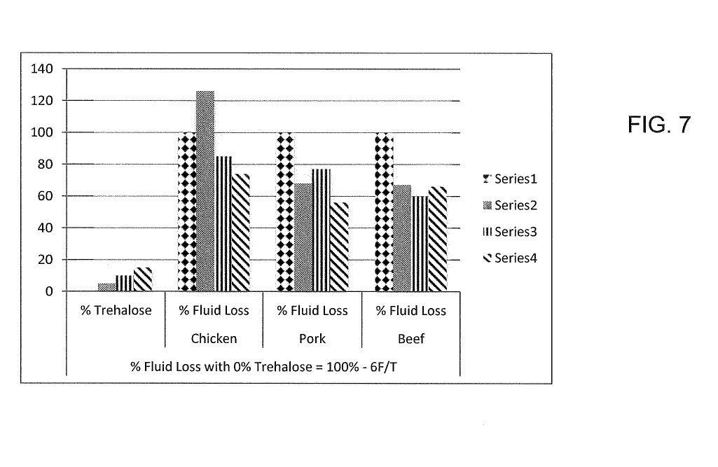

FIG. 7 discloses a re-plotting of fluid loss data, where the amount of fluid lost with 0% trehalose treatment, was set at 100% fluid loss. As mentioned above, these data were from the second freeze/thaw cycle. Maximal influence on reducing fluid loss for chicken, pork, and beef, respectfully, was at 15%, 15%, and 10%, trehalose. In FIG. 7, the first series of bars represents a legend to the figure (not experimental data).

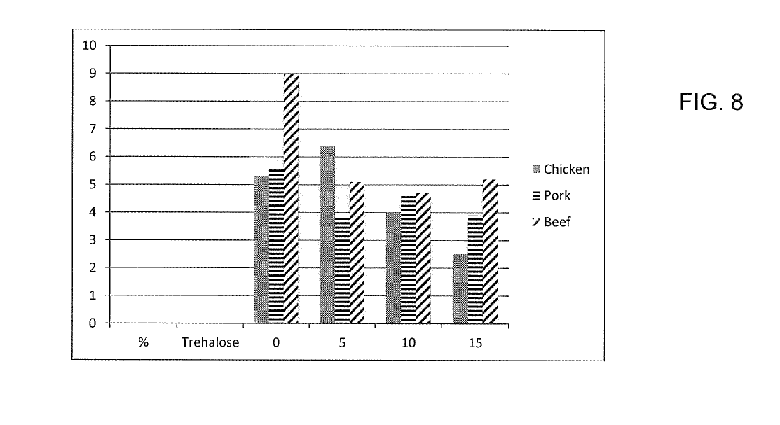

FIG. 8 reveals weight loss measurements for the second freeze/thaw cycle. Relative weight loss may differ, somewhat, than relative fluid volume losses, because weight loss is due to losses of fluid and protein, and solutes such as amino acids, metabolites, and minerals. Weight loss with chicken, pork, and beef, was lowest with 15%, 5% (or 15%), and 15% trehalose, respectively.

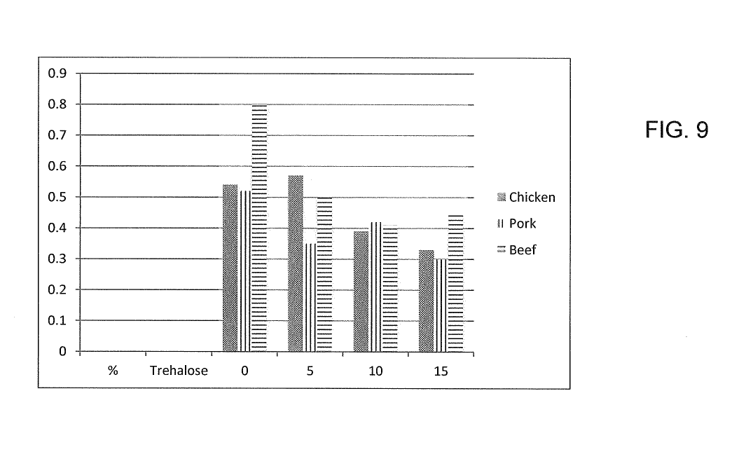

FIG. 9 reveals fluid loss, expressed as mL fluid lost/10 grams of meat, during the second freeze/thaw cycle. For chicken, pork, and beef, the lowest values for this parameter were found where treatment was with 15%, 15%, and 10%, trehalose

Figures with Cumulative Data from First Week and Second Week

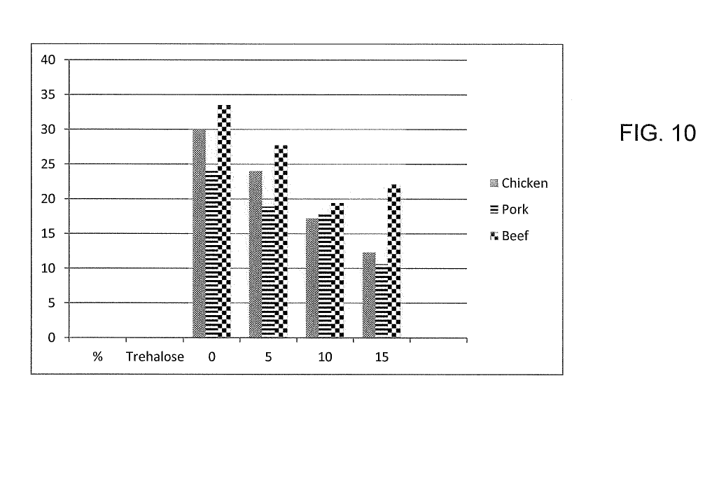

FIG. 10 discloses cumulative results, for the total volume of fluid loss, for the 1^{st} and 2^{nd} freeze/thaw cycles. The term cumulative refers to the sum of fluid losses for the first week and for the second week. For chicken, pork, and beef, maximal reduction in cumulative loss occurred at 15%, 15%, and 10% trehalose.

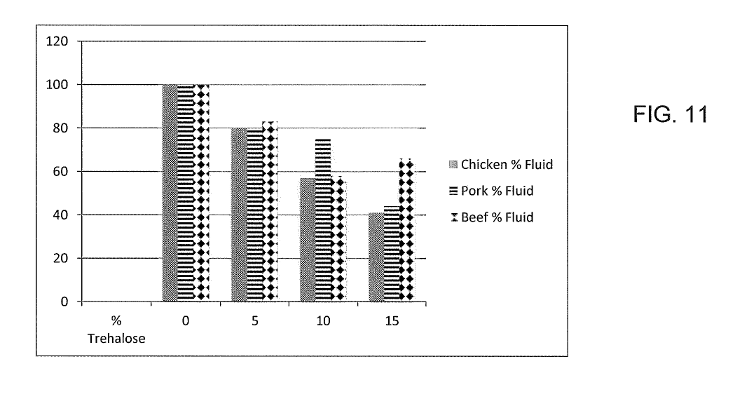

FIG. 11 is a replot of the data from the preceding figure, where fluid loss with zero percent (0%) trehalose treatment was set at 100% fluid loss. Cumulative results for 1^{st} and 2^{nd} freeze/thaw cycles. For chicken, pork, and beef, maximal reduction in cumulative loss occurred at 15%, 15%, and 10% trehalose. The data indicate that for each type of meat, there exists a linear dose-response relationship between increasing trehalose concentration and reduction of fluid loss, where maximal effect is reached at 15% (or greater) for chicken and pork, and were a plateau in maximal effect occurs at 10-15%, or where a region of maximal effect occurs in between 10-15%, for beef.

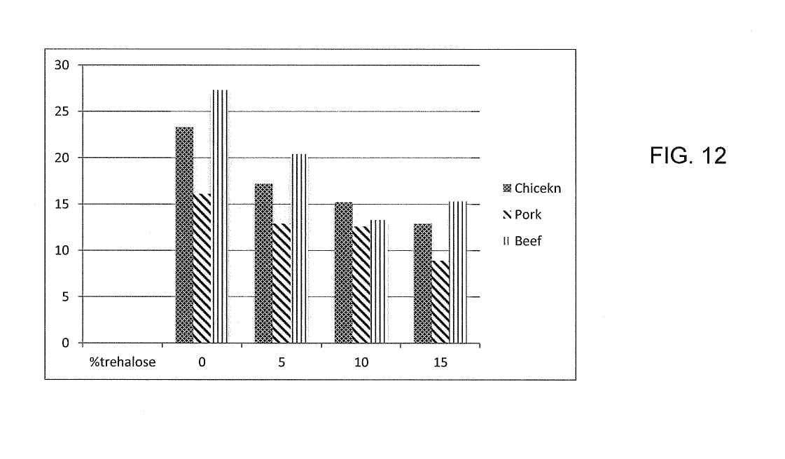

FIG. 12 reveals cumulative weight loss results for 1^{st} and 2^{nd} freeze/thaw cycles. The majority of the weight loss occurred during the first week. Thus, data on cumulative weight loss more reflect weight loss data from the first week, and less reflect weight loss data from the second week. For chicken and pork, maximal effect of trehalose occurred at 15% trehalose, while for beef, maximal effect occurred at 10% trehalose, or alternatively, at 10-15% trehalose, or at a point between 10-15%.

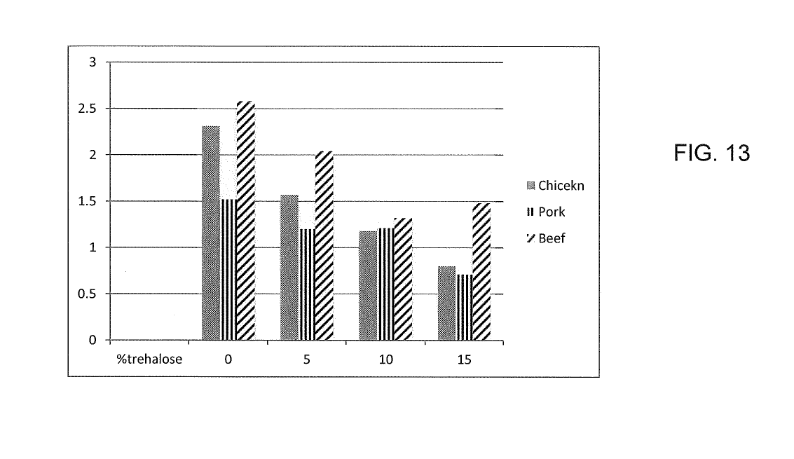

FIG. 13 expresses fluid loss in terms of loss per 10 grams of meat. What is shown is cumulative results for 1^{st} and 2^{nd} freeze/thaw cycles. Maximal influence of trehalose at reducing fluid loss was at 15% for chicken and pork, and at 10-15% for beef.

Figures that Separately Show Cumulative Results, Results from the First Week, and Results from the Second Week

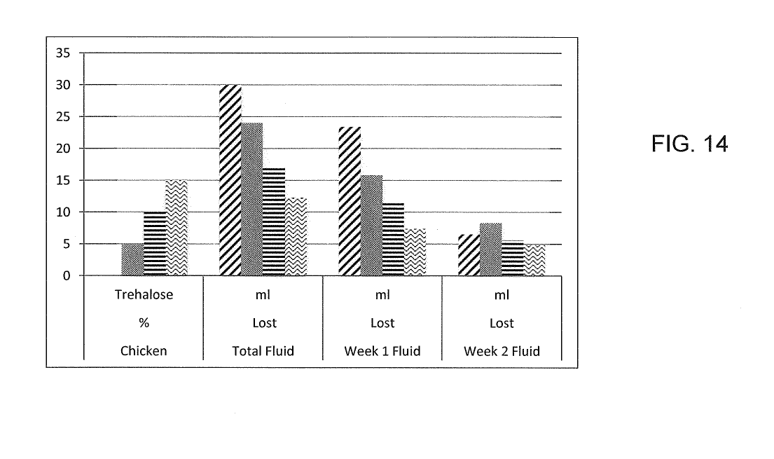

FIG. 14 (chicken) discloses cumulative results for fluid loss, fluid loss results after the 1^{st} freeze/thaw cycle, and fluid loss results after the 2^{nd} freeze/thaw cycle. The first cycle of histogram bars is a legend (not experimental data points). The plot dramatically shows that more of the fluid loss occurred during the first week, and that during the second week, the additional fluid loss was relatively low. This dramatic effect actually was seen at the lower treatment levels of trehalose, and with 15% trehalose, the release of water during the first week the low level of release of fluid was about the same as the low level of release of fluid occurring during the second week. During the first week, 15% trehalose had the maximal effect, as compared to other trehalose concentrations. During the second week, 15% also had the maximal effect, as compared to other trehalose levels.

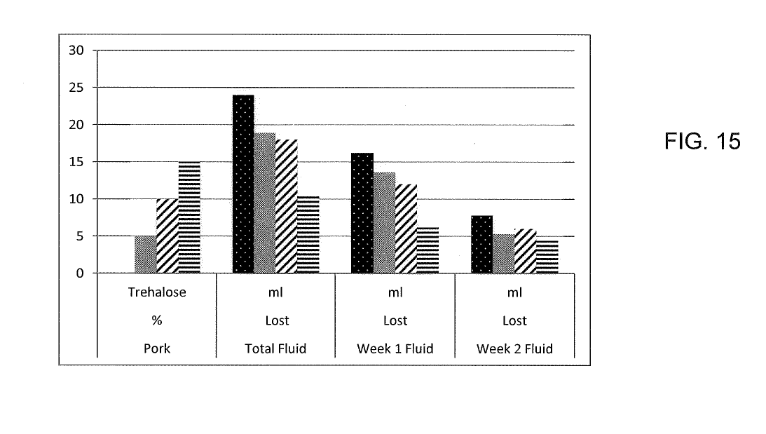

FIG. 15 (pork) discloses cumulative results for fluid loss, fluid loss results after the 1^{st} freeze/thaw cycle, and fluid loss results after the 2^{nd} freeze/thaw cycle. The first cycle of bars is a legend (not data points). The plot dramatically shows that more of the fluid loss occurred during the first week, and that during the second week, the additional fluid loss was relatively low. This dramatic effect actually was seen at the lower treatment levels of trehalose. But with 15% trehalose, the release of water during the first week the low level of release of fluid was about the same as the low level of release of fluid occurring during the second week. During the first week, 15% trehalose had the maximal effect, as compared to other trehalose concentrations. During the second week, 15% also had the maximal effect, as compared to other trehalose levels.

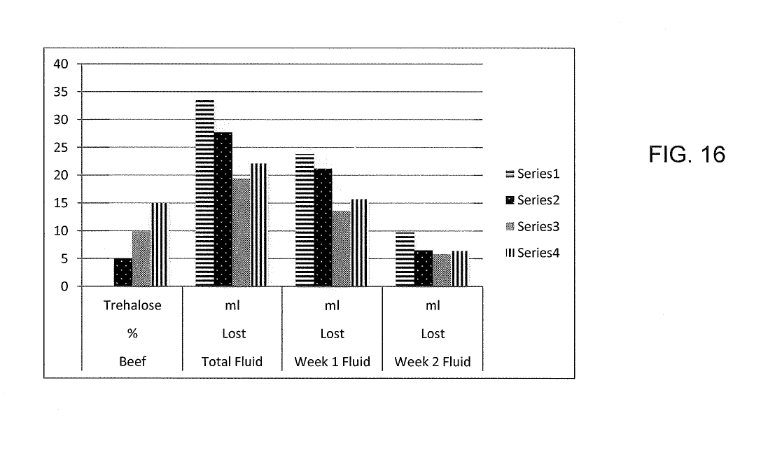

FIG. 16 (beef) shows separate plots of cumulative fluid loss, 1^{st} freeze/thaw cycle fluid loss, and 2^{nd} freeze/thaw cycle fluid loss. For beef, fluid loss at each respective trehalose value, for the first week, was roughly 2-3 times the fluid loss of each respective trehalose value, for the second week.

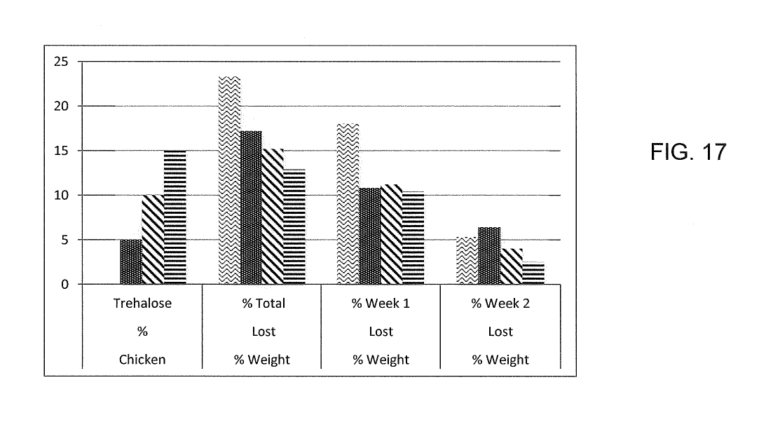

FIG. 17 (chicken) shows separate plots of weight loss, that is cumulative results, 1^{st} freeze/thaw cycle, and 2^{nd} freeze/thaw cycle results. For the first week, trehalose reduced weight loss, where this reduction was about the same (plateau in trehalose effect) for 5%, 10%, and 15% trehalose. For the second week, trehalose also reduced weight loss, where weight reduction by trehalose was only found at 10% and 15% trehalose.

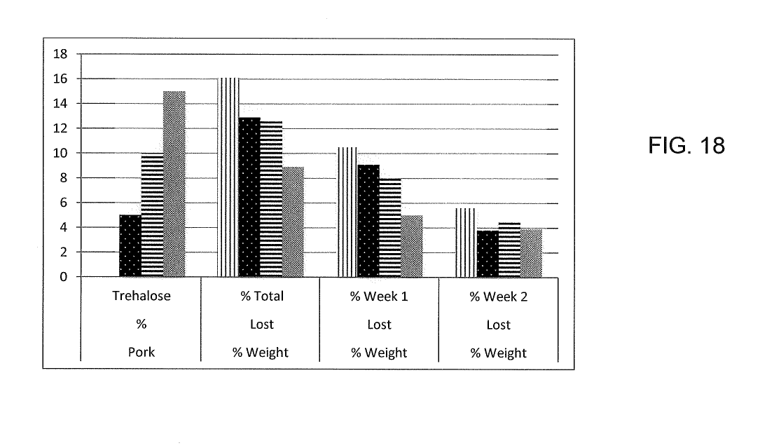

FIG. 18 (pork) shows separate plots of weight loss, that is, cumulative results, 1^{st} freeze/thaw cycle, and 2^{nd} freeze/thaw cycle results. For the first week, trehalose reduced weight loss, where this reduction was progressively effective for 5%, 10%, and 15% trehalose. For the second week, trehalose also reduced weight loss, where weight reduction seemed to plateau when trehalose was in the range of 5-15% trehalose.

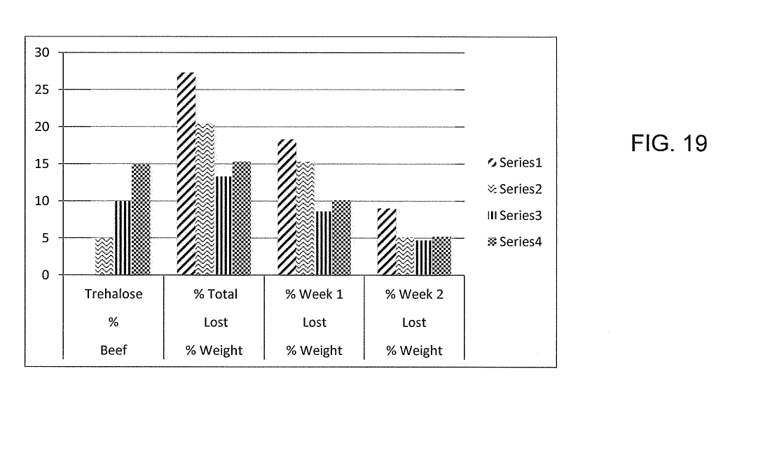

FIG. 19 (beef) shows separate plots of weight loss, i.e., cumulative results, 1^{st} freeze/thaw cycle, and 2^{nd} freeze/thaw cycle results. For the first week, trehalose reduced weight loss, where this reduction was progressively effective for 5%, 10%-15% trehalose. For the second week, trehalose also reduced weight loss, where weight reduction seemed to plateau when trehalose was in the range of 5-15% trehalose.

### Figures Showing Fracturing of Muscle Fibers and Fluid Between Fibers

Samples were taken of meat treated with 0%, 5%, 10%, or 15%, trehalose, where the samples were fixed in formalin, stained with hematoxylin and eosin, and examined with a microscope, under moderate power or high power. In general, hemotoxylin stain results in blue color, and eosin results in red, pink, and orange colors. Moderate Power=100× (Eyepiece=10× and Objective=10×). High Power=250× (Eyepiece=10× & Objective=25×).

With 15% trehalose-treated meat, as compared with 0% trehalose-treated meat, increase in horizontal fractures was seen, in samples where meat had been treated with six freeze/thaw cycles over the course of two weeks. “Horizontal” refers to a line perpendicular to the longitudinal axis of the muscle fiber. Increases, but to a lesser degree than with 15% trehalose, were also seen where meat had been treated with 5% trehalose or 10% trehalose. The above changes were seen with beef, chicken, and pork. With 15% trehalose, examination with microscope showed an increase in fluid in between fibers. With pork samples, 15% trehalose resulted in more fluid in between muscle fibers, that is, an increase in space in between muscle fibers, and also an increase in debris in the spaces between muscle fibers. Pork samples showed a more shortened fiber then seen with chicken or beef. As compared with 0% trehalose-treated pork, the 15% trehalose-treated pork resulted in horizontal fractures, as well as increased space between muscle fibers, and debris in these spaces.

Wider white lines in the photographs are likely between bundles, while thinner white lines are likely between fibers (not between bundles). This characterization holds true for beef, chicken, and pork.

Table 1 outlines some of the features shown in the various figures.

The characteristic of a bundle, or a myofibril, as being broken can be quantified in the following way. A field of the microscopic view under high power, as defined above, is used as the area of consideration. This area can be, e.g., 400 square micrometers. If the area has only one fragment, then fragmentation is low. If the area has over ten fragments, then fragmentation is high. If the area has between two and ten fragments, then fragmentation is moderate.

The following concerns a relationship between water loss from the meat, and fragments observed in the meat. Trehalose increases water content within the meat thus decreasing water loss from the meat. With increased water content within the meat, the freeze/thaw cycles can result in the meat fiber fracturing due to the swelling of water when it freezes, shrinking when it thaws, and re-swelling again with each freezing. The phenomenon of fragmentation is similar to that where frozen water can break up cracks in boulders or rocks. The trehalose itself does not cause any fiber fracture as the fracturing is actually secondary to the increased water content in the meat that breaks up the fibers with ice formation.

The characteristic of a bundle, or a myofibril, being broken and moved around can be quantified as follows. First, the overall longitudinal axis of the bundle or fibril is determined. Second, a given area containing at least ten fragments is defined in a microscopic field, e.g., under high power magnification as defined above. Third, the edge of each fragment, which was originally aligned with the longitudinal axis in the intact bundle or fibril is located. Fourth, the angle of the edge, with respect to the overall longitudinal axis is measured. Fifth, angles of ten different fragments are measured. Sixth, the angles are added together. If the sum of the angles is zero degrees, that is, if all of the fragments are aligned with the overall longitudinal axis, then the sample of meat is determined (or defined) to be fragmented, but not moved around. If the sum of angles is about 300 degrees, for example, where ten fragments are each rotated by about 30 degrees, then the structural feature of being “moved around” is high.

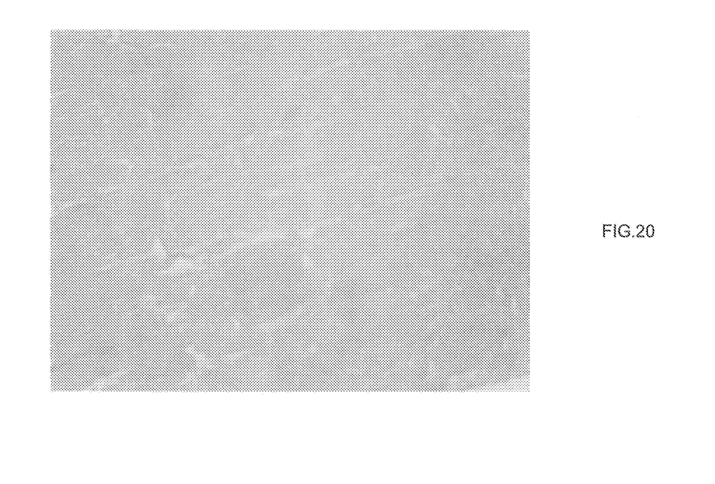

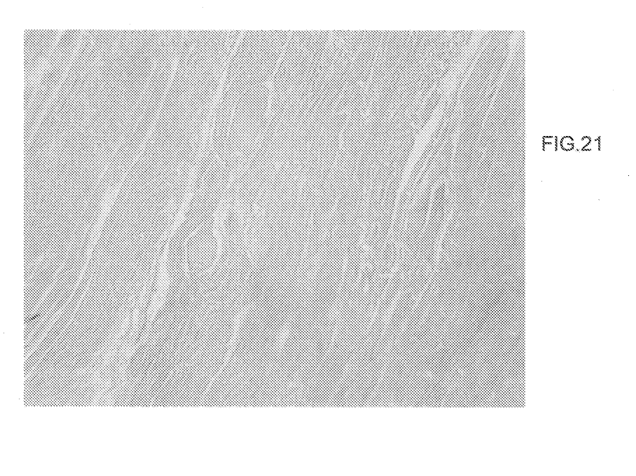

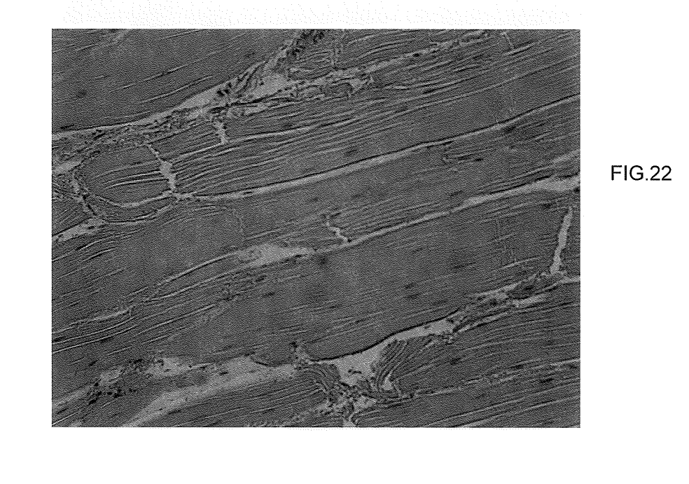

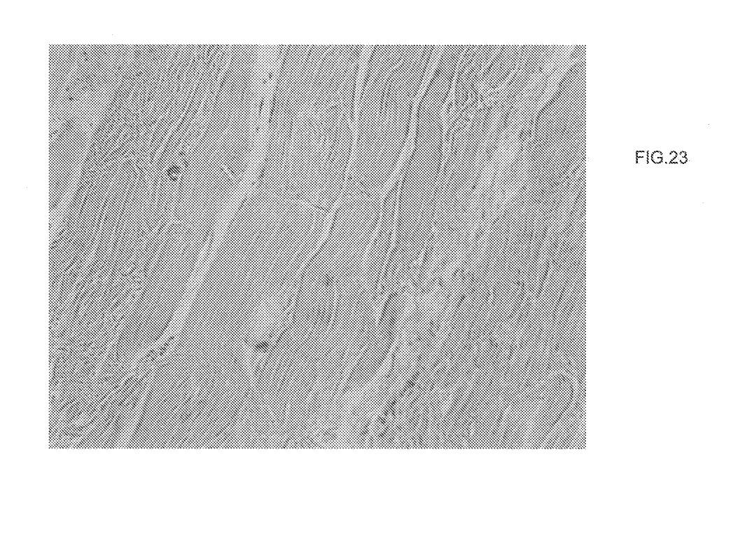

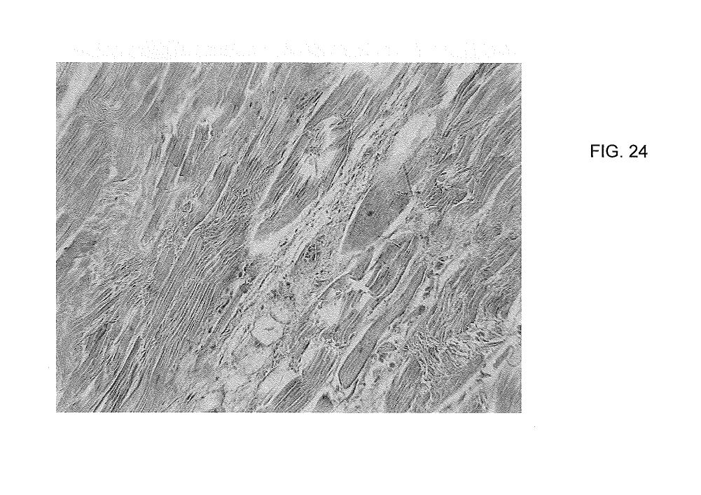

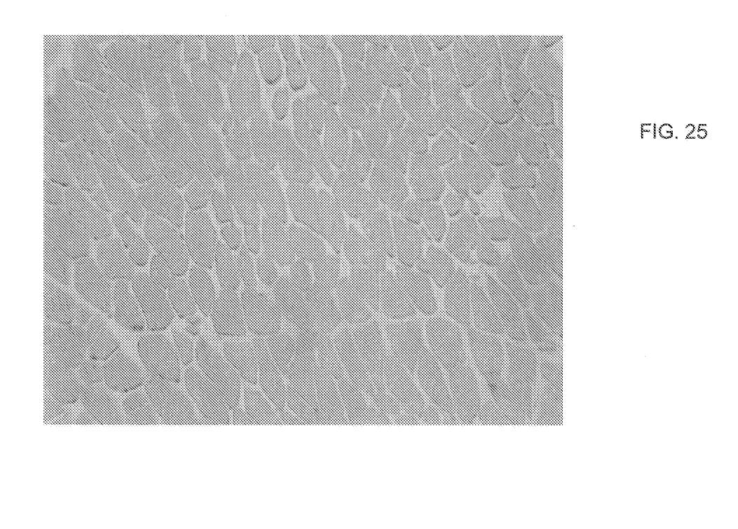

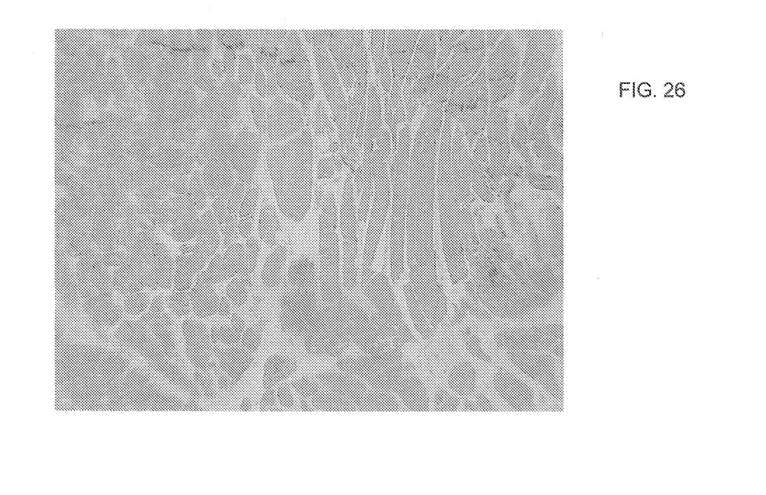

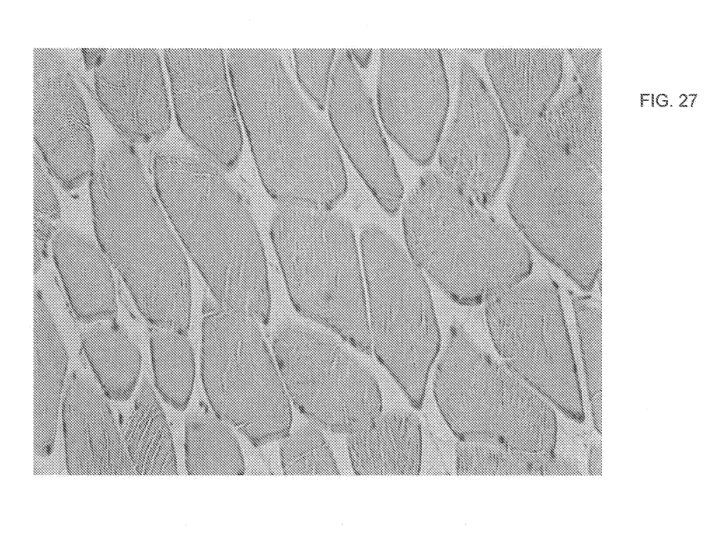

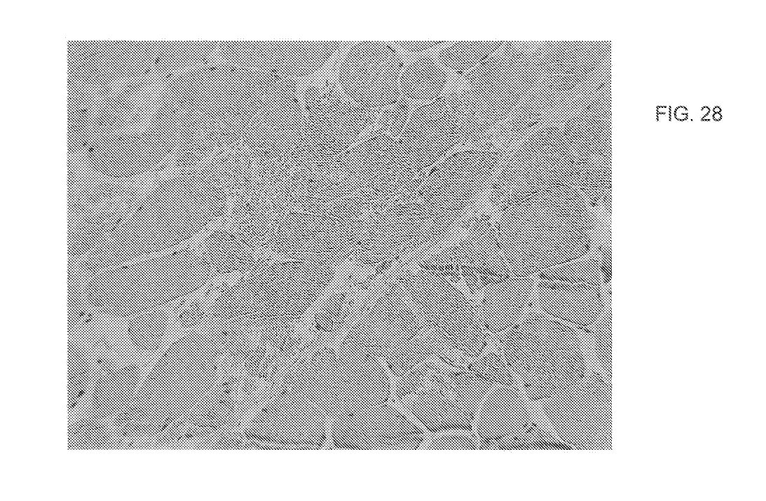

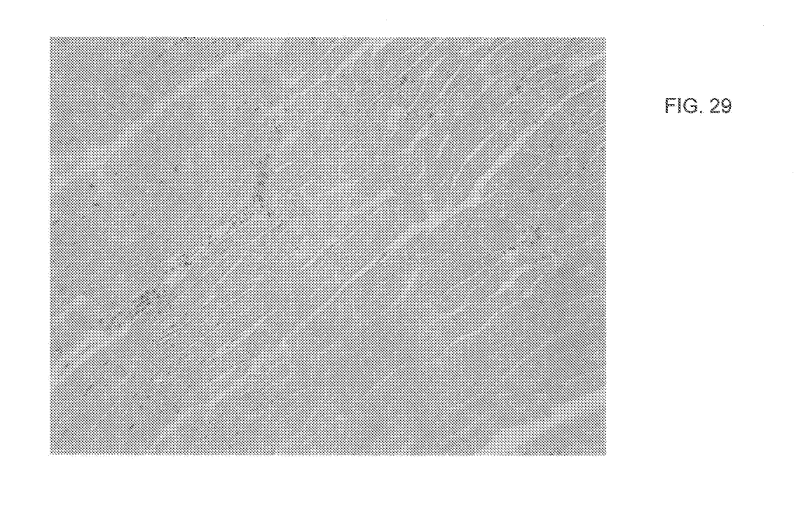

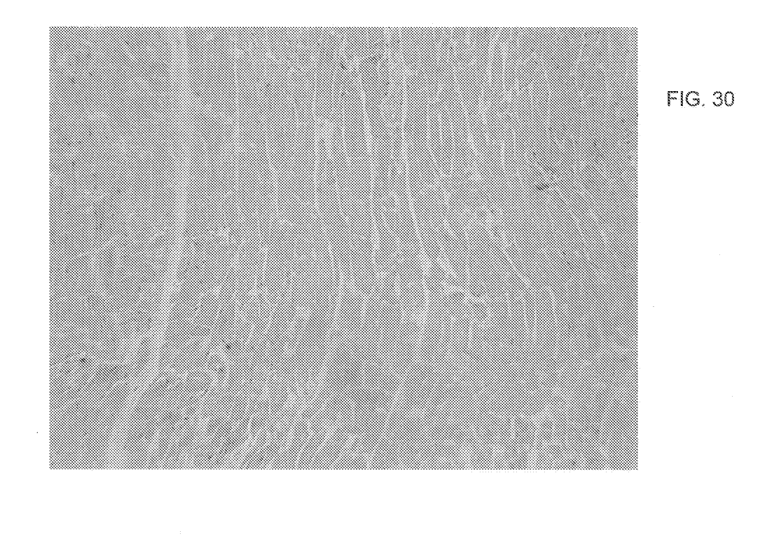

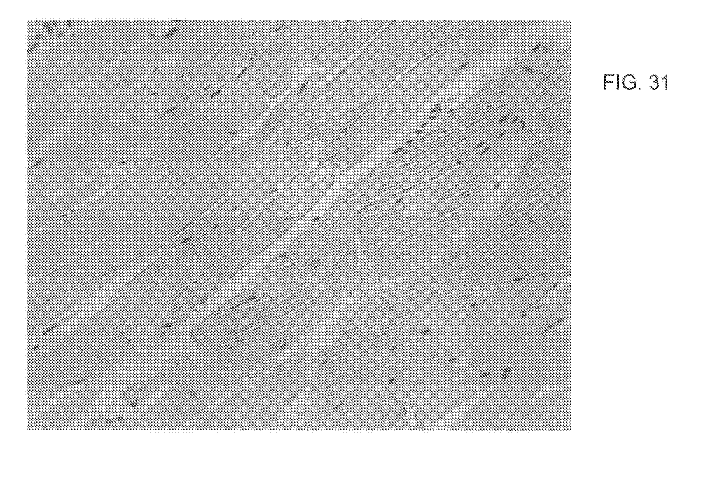

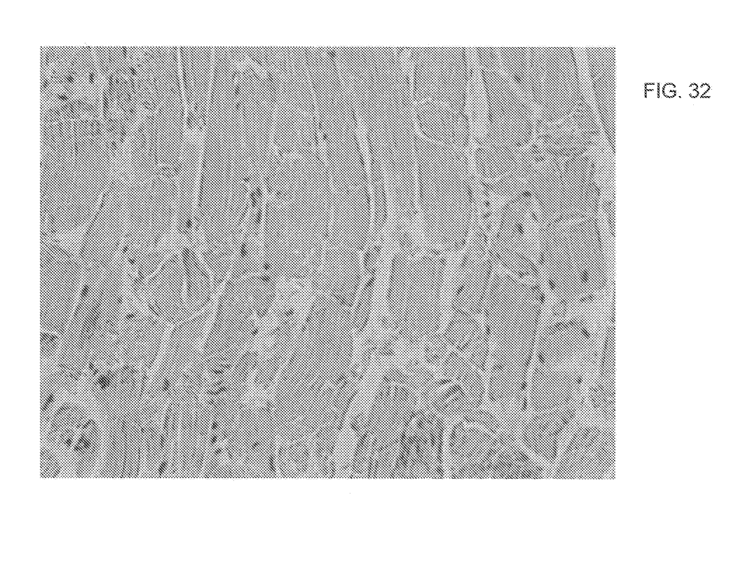

TABLE 1
Light microscopy images of meat, pre-treated with either
0% trehalose or 15% trehalose, and then subjected
to two weeks of freeze/thaw cycling.

| | | Percent | |
|---|---|---|---|
| Figure | Meat | trehalose | Observation |
| FIG. 20 | chicken | 0% | Some fractures. |
| FIG. 21 | chicken | 15% | Stained blue color in spaces between |
| | | | bundles. Fractures with debris moved |
| | | | around. |
| FIG. 22 | chicken | 0% | Small partial fractures. Substantial |
| | | | uniformity of fibrils. |
| FIG. 23 | chicken | 15% | Complete fracture |
| FIG. 24 | chicken | 15% | Complete fractures without debris, and |
| | | | complete fracture with much debris in |
| | | | area of fractures. Areas of debris where |
| | | | debris is moved around, and areas of |
| | | | debris where debris is not moved around. |
| FIG. 25 | pork | 0% | Substantial uniformity of fibrils. |
| | | | Essentially no debris and no fractures. |
| FIG. 26 | pork | 15% | Many fractures, debris between fiber |
| | | | bundles, and debris moved around. |
| FIG. 27 | pork | 0% | Substantial uniformity of fibrils, with |
| | | | essentially no fractures or partial fractures. |
| FIG. 28 | pork | 15% | Debris within fibrils, and debris in areas |
| | | | in between bundles or in between fibrils. |
| FIG. 29 | beef | 0% | Substantial uniformity of fibrils. |
| FIG. 30 | beef | 15% | Extensive fractures where debris is not |
| | | | moved around, and extensive fractures |
| | | | where debris is moved around. |
| FIG. 31 | beef | 0% | Substantial uniformity of fibrils, with |
| | | | occasional partial or full fractures. |
| FIG. 32 | beef | 15% | Extensive full fractures, and extensive |
| | | | moving around of debris. |

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant.

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC §132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

What is claimed is:

1. A method for processing a first composition that comprises muscle fibers, the method comprising:
Step a. Contacting a solution of a first concentration of trehalose (Solution A) to a first composition that comprises muscle fibers;
Step b. Incubating the first composition that comprises muscle fibers, for a pre-determined time, at a first temperature that is above freezing, in the presence of the Solution A; and,
Step c. Reducing or eliminating the presence of the Solution A;
wherein the concentration of trehalose in the Solution A is capable of reducing weight loss of the first composition and is also capable of reducing water loss from the first composition, as determinable by subjecting to at least three cycles of freezing and thawing, as compared to a second control composition that comprises muscle fibers that was not incubated in the presence of trehalose, where the second control composition is subjected to the at least three cycles of freezing and thawing.

2. The method of claim 1 wherein the first composition is meat for human consumption.

3. The method of claim 1 that does not comprise freezing.

4. The method of claim 1 that further comprises freezing following Step c.

5. The method of claim 1, wherein the reducing or eliminating of the Solution A comprises draining or blotting.

6. The method of claim 1, wherein the pre-determined time is at least 12 hours and the first temperature is 2-10 degrees C.

7. The method of claim 1, wherein the first composition that comprises muscle fibers does not comprise an organ or gland.

8. The method of claim 1, wherein the first composition that comprises muscle fibers comprises meat that is one or more of beef, pork, poultry, fish, or shellfish.

9. The method of claim 1, wherein the first concentration of trehalose is at least 5% trehalose.

10. The method of claim 1, wherein the first concentration of trehalose is at least 10% trehalose.

11. The method of claim 1, wherein the Solution A contains at least 5% trehalose, wherein three freeze-thaw cycles results in a fluid loss of N mL (N is a number) from a second composition (comparator composition) that is not treated with trehalose prior to freeze-thawing, and wherein three freeze-thaw cycles results in a fluid loss of under 80% of N mL from the first composition, wherein the first composition is treated with at least 5% trehalose prior to freeze-thawing.

12. The method of claim 1, wherein the Solution A contains at least 5% trehalose, wherein three freeze-thaw cycles results in a fluid loss of N mL (N is a number) from a second composition (comparator composition) that is not treated with trehalose prior to freeze-thawing, and wherein three freeze-thaw cycles results in a fluid loss of under 70% of N mL from the first composition, wherein the first composition is treated with at least 5% trehalose prior to freeze-thawing.

13. The method of claim 1, wherein the Solution A is at least 5% trehalose, wherein three freeze-thaw cycles results in a fluid loss of N mL (N is a number) from a second composition (comparator composition) that is not treated with trehalose prior to freeze-thawing, and wherein three freeze-thaw cycles results in a fluid loss of under 60% of N mL from the first composition, wherein the first composition is treated with at least 5% trehalose prior to freeze-thawing.

14. The method of claim 1, wherein the contacting and incubating comprises one or more of soaking, dipping, or spraying.

15. The method of claim 1, wherein the first concentration of trehalose is at least 5% trehalose, and:
(i) wherein the first and second compositions comprise poultry meat, wherein three freeze-thaw cycles results in a weight loss of at least 15% of a second composition (comparator composition) that is not treated with trehalose prior to freeze-thawing, and wherein three freeze-thaw cycles results in a weight loss of under 13% of the first composition, wherein the first composition is treated with at least 5% trehalose in Step b;
(ii) wherein the first and second compositions comprise pork, wherein three freeze-thaw cycles results in a weight loss of at least 8% of a second composition (comparator composition) that is not treated with trehalose prior to freeze-thawing, and wherein three freeze-thaw cycles results in a weight loss of under 7% of the first composition, wherein the first composition is treated with at least 5% trehalose in Step b; or
(iii) wherein the first and second compositions comprise beef, wherein three freeze-thaw cycles results in a weight loss of at least 15% of a second composition (comparator composition) that is not treated with trehalose prior to freeze-thawing, and wherein three freeze-thaw cycles results in a weight loss of under 13% of the first composition, wherein the first composition is treated with at least 5% trehalose in Step b.

16. The method of claim 1, wherein the first concentration of trehalose is at least 5% trehalose, wherein three freeze-thaw cycles results in a fluid loss of at least Y mL/10 grams of a second composition of comparator composition that is not treated with trehalose prior to freeze-thawing, and,
(i) wherein three freeze-thaw cycles results in a fluid loss of under 0.5 Y mL/10 grams of a first composition, wherein the first composition and second composition comprise poultry meat;
(ii) wherein three freeze-thaw cycles results in a fluid loss of under 0.7 Y mL/10 grams of a first composition, wherein the first composition and second composition comprise pork; or
(iii) wherein three freeze-thaw cycles results in a fluid loss of under 0.7 Y mL/10 grams of a first composition, wherein the first composition and second composition comprise beef.

17. A method for processing a first composition that comprises muscle fibers, the method comprising:
(i) contacting a solution of a first concentration of trehalose (Solution A), that is at least 5% trehalose, to a first composition that comprises muscle fibers;
(ii) incubating the first composition that comprises muscle fibers, for a pre-determined time, at a first temperature that is above freezing, in the presence of the Solution A; and
(iii) reducing or eliminating the presence of the solution of the first concentration of trehalose;
wherein the first composition that comprises muscle fibers comprises increased number of horizontal fractures and increased number of moved around fragments, as determined by the steps of:
(I) the first composition that comprises muscle fibers is incubated in the Solution A that is at least 5% trehalose for 12 hours at 4 degrees C., and the second composition (comparator composition) is incubated a control solution that does not contain trehalose for 12 hours at 4 degrees C.;
(II) the Solution A is removed by draining and the control solution is removed by draining;
(III) the first composition that comprises muscle fibers and the second composition that comprises muscle fibers are each subjected to two weeks of freeze-thaw cycling (freeze 24 h/thaw 24 h); and
(IV) the first composition that comprises muscle fibers and the second composition that comprises muscle fibers are each fixed with formalin, stained with hematoxylin and eosin, and examined with a microscope.

18. The method of claim 17, wherein the increased number of horizontal fractures is at least two-fold increased, and increased number of moved around fragments is at least two-fold increased.

19. A composition that comprises trehalose-treated muscle fibers, prepared by a method comprising:
(a) contacting a solution of a first concentration of trehalose (Solution A) to a first composition that comprises muscle fibers;
(b) incubating the first composition that comprises muscle fibers, for a pre-determined time, at a first temperature that is above freezing, in the presence of the solution of the first concentration of at least 5% trehalose; and
(c) reducing or eliminating the presence of the Solution A;
wherein the concentration of trehalose in the Solution A is capable of reducing weight loss of the first composition and is also capable of reducing water loss from the first composition, when subjected to at least three cycles of freezing and thawing, as compared to a second control composition that comprises muscle fibers, wherein the second control composition is not incubated in the presence of trehalose.

20. A composition that comprises a trehalose-treated composition that comprises muscle fibers, wherein the composition is prepared by a method comprising:
(a) contacting a solution of a first concentration of trehalose (Solution A), that is at least 5% trehalose, to a first composition that comprises muscle fibers;
(b) incubating the first composition that comprises muscle fibers, for a pre-determined time, at a first temperature that is above freezing, in the presence of the Solution A; and
(c) reducing or eliminating the presence of the Solution A;
wherein the first composition that comprises muscle fibers comprises increased number of horizontal fractures and increased number of moved around fragments, as determined by the steps of:
(i) the first composition that comprises muscle fibers is incubated in a Solution A that is at least 5% trehalose for 12 hours at 4 degrees C., and the second composition (comparator composition) is incubated a control solution that does not contain trehalose for 12 hours at 4 degrees C.;
(ii) the Solution A is removed by draining and the control solution is removed by draining;
(iii) the first composition that comprises muscle fibers and the second composition that comprises muscle fibers are each subjected to two weeks of freeze-thaw cycling (freeze 24 h/thaw 24 h); and
(iv) the first composition that comprises muscle fibers and the second composition that comprises muscle fibers are each fixed with formalin, stained with hematoxylin and eosin, and examined with a microscope.
